(19) United States
(12) Patent Application Publication
(10) Pub. No.: US 2023/0059997 A1
(43) Pub. Date: Feb. 23, 2023

(54) DENTAL IMPLANT WITH IMPROVED STABILIZATION THREAD FORM AND CUTTING ELEMENTS

(71) Applicant: EVOLLUTION IP HOLDINGS, INC., Birmingham, AL (US)

(72) Inventors: John J. BELLANCA, Birmingham, AL (US); Fred J. MOLZ, IV, Montevallo, AL (US)

(73) Assignee: EVOLLUTION IP HOLDINGS, INC., Birmingham, AL (US)

(21) Appl. No.: 17/974,608

(22) Filed: Oct. 27, 2022

Related U.S. Application Data
(63) Continuation-in-part of application No. 17/845,581, filed on Jun. 21, 2022.
Application No. 17/845,581 is a continuation of application No. 16/157,530, filed on Oct. 11, 2018, now Pat. No. 11,382,724.
(60) Provisional application No. 62/570,890, filed on Oct. 11, 2017.

(51) Int. Cl. A61C 8/00

(52) U.S. Cl. CPC A61C 8/0025; A61C 8/0037; A61C 8/0022; A61C 8/0024

(57) ABSTRACT

An implant for insertion within a maxillofacial bone of a patient, for example a dental implant, including a three-dimensional stabilization thread form extending along at least a portion of the implant body in a first helical direction, and one or more grooves or channels extending through the three-dimensional stabilization thread form in a generally opposite second helical direction, whereby one or more cutting edges are formed at the intersection of the one or more grooves or channels with the three-dimensional stabilization thread form.

### CROSS-REFERENCE TO RELATED APPLICATION

This application is a continuation in part of U.S. Non-Provisional patent application Ser. No. 17/845,581 filed Jun. 21, 2022, which is a continuation of U.S. Non-Provisional patent application Ser. No. 16/157,530 filed Oct. 11, 2018, now U.S. Pat. No. 11,382,724, which claims the benefit of U.S. Provisional Patent Application Ser. No. 62/570,890 filed Oct. 11, 2017, the entireties of which are hereby incorporated by reference herein. U.S. Pat. No. 11,006,990 is also incorporated by reference herein.

### TECHNICAL FIELD

The present invention relates generally to the field of dental implants, and more particularly to a dental implant having a three-dimensional stabilization thread form and cutting element features.

### SUMMARY

In example embodiments, the present invention provides a dental implant comprising proximal and distal ends. An external thread extends helically in a first helical direction along at least a portion of the implant's length between the proximal and distal ends. At least a portion of the thread has a three-dimensional profile having a root portion with a smaller thickness dimension transverse to the helical path, and a crest portion with a larger thickness dimension transverse to the helical path. The implant further comprises one or more cutting flutes arranged along a second helical direction opposite the first helical direction and extending through at least a portion of the external thread. The intersections of the cutting flute(s) with the external threads create one or more cutting elements, features or edges that may assist in the insertion of the implant into the bone.

In a first aspect, the invention relates to a dental implant including an implant body having distal and proximal ends, with a longitudinal axis extending lengthwise therethrough, and defining a length between the distal and proximal ends. The implant preferably further includes an external thread form extending along a generally helical path in a first helical direction around the longitudinal axis and along at least a portion of the length of the implant body between the distal and proximal ends, the external thread form at least partially comprising a three-dimensional thread profile having a root portion with a smaller thickness dimension transverse to the helical path, and a crest portion with a larger thickness dimension transverse to the helical path. The implant preferably further includes at least one cutting flute extending along a generally helical path around the longitudinal axis in a second helical direction opposite the first helical direction and along at least a portion of the length of the implant body, wherein at least one cutting element is formed at an intersection of the at least one cutting flute with the external thread form.

In another aspect, the invention relates to a dental implant including an implant body having a first end and a second end, defining a length between the first and second ends, and a longitudinal axis extending lengthwise therethrough, wherein at least a portion of the implant body is tapered from a larger diameter toward the first end to a smaller diameter toward the second end. The implant preferably further includes an external thread form extending along at least a portion of the length of the implant body and around the longitudinal axis in a first rotational direction, at least a portion of the external thread form comprising a three-dimensional stabilization thread profile having a transverse crest thickness greater than a transverse root thickness. The implant preferably further includes at least one channel extending through the external thread form and forming at least one cutting element at an interface of the external thread form with the at least one channel, the at least one channel extending around the longitudinal axis in a second rotational direction opposite the first rotational direction.

In still another aspect, the invention relates to a method of manufacturing a dental implant. The method preferably includes providing an implant body; machining external threads along at least a portion of the implant body in a first helical direction, at least a portion of the threads comprising a three-dimensional stabilization thread form; and machining at least one flute along the implant body in a second helical direction generally opposite the first helical direction, whereby at least one cutting element is created at an intersection of the at least one flute and the threads.

These and other aspects, features and advantages of the invention will be understood with reference to the drawing figures and detailed description herein and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a front plan view of an implant according to an example embodiment of the present invention, the implant comprising a multi-lead thread form.

FIG. 2 is a cross-sectional view of the implant of FIG. 1.

FIG. 3 is a detailed view of a portion of the thread form of FIG. 2.

FIG. 4A and FIG. 4B show a vector diagram of the retention forces of the three-dimensional stabilization thread form of the implant of FIG. 1 in comparison to the lack of retentive forces of a standard thread.

FIG. 5 is a front plan view of an implant according to another example embodiment of the present invention.

FIG. 6 is a cross-sectional view of the implant of FIG. 5.

FIG. 7 is a detailed view of a portion of the thread form of FIG. 6.

FIG. 8 is a cross-sectional view of the implant according to another example embodiment of the present invention.

FIG. 9 is a detailed view of a portion of the thread form of FIG. 8.

FIG. 10 is a cross-sectional view of the implant according to another example embodiment of the present invention.

FIG. 11 is a detailed view of a portion of the thread form of FIG. 10.

FIG. 12 is a cross-sectional view of the implant according to another example embodiment of the present invention.

FIG. 13 is a detailed view of a portion of the thread form of FIG. 12.

FIG. 14 is a cross-sectional view of the implant according to another example embodiment of the present invention.

FIG. 15 is a detailed view of a portion of the thread form of FIG. 14.

FIG. 16 is a cross-sectional view of the implant according to another example embodiment of the present invention.

FIG. 17 is a detailed view of a portion of the thread form of FIG. 16.

FIG. 18 is a front plan view of an implant according to another example embodiment of the present invention.

FIG. 19 is a front plan view of an implant according to another example embodiment of the present invention.

FIG. 20 is a cross-sectional view of the implant according to another example embodiment of the present invention.

FIG. 21 is a detailed view of a portion of the thread form of FIG. 20.

FIG. 22 is a detailed perspective view of a portion of an implant according to another example embodiment of the present invention, the implant comprising a three-dimensional thread form defining one or more edges thereon and prior to post processing.

FIG. 23 is a detailed view of the implant of FIG. 22, showing the edges of the thread form being rounded and the surfaces thereof being roughened after completion of post processing of the implant.

FIG. 24 is a perspective view of an implant according to another example embodiment of the present invention.

FIG. 25 is a front plan view of the implant of FIG. 24.

FIG. 26 is a cross sectional view of the implant of FIG. 24.

FIG. 27 is a detailed, cross-sectional view of a portion of the thread form of FIG. 26.

FIG. 28 is a cross sectional view of an implant with only a secondary helix.

FIG. 29 is a front plant view of the implant of FIG. 28.

FIG. 30 is a sectional view of a blank used to create an implant according to example methods of fabrication according to the present invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

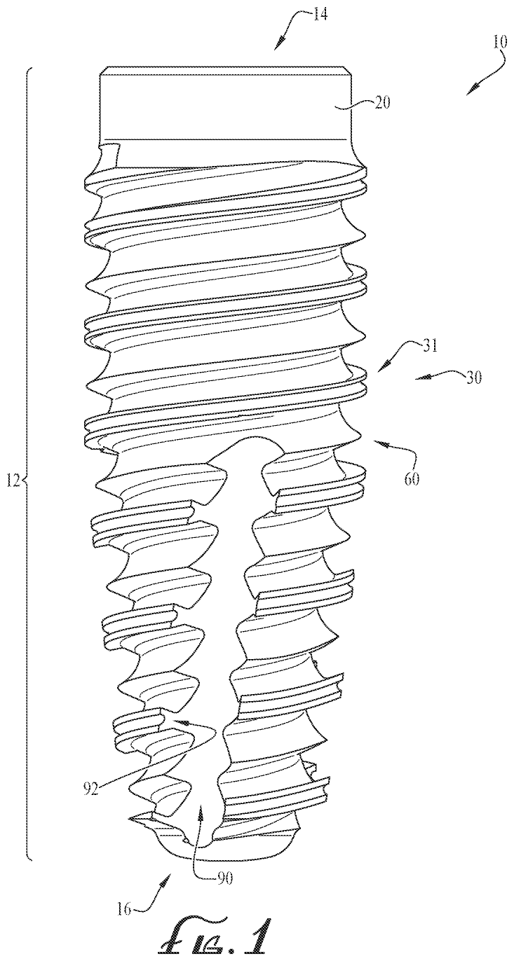

With reference now to the drawing figures, wherein like reference numbers represent corresponding parts throughout the several views, FIG. 1 shows a dental implant 10 for supporting an abutment onto which a prosthetic tooth is mounted. The implant is generally inserted into maxillofacial bone. In example embodiments, the implant 10 comprises a generally elongate body 12 comprising a first end 14 and a generally opposite second end 16. The first end 14 comprises an upper cylindrical portion 20 defining an abutment receiver that can vary in length (e.g., for receiving an abutment and abutment screw; internal geometry present but not shown).

In example embodiments, the implant 10 comprises one or more threads 30 formed on the body 12 between the first and second ends 14, 16, for example, which preferably assist in resisting or restricting three-dimensional movement of the implant 10 within a full or partial osteotomy. In example embodiments, the one or more threads 30 comprise a feature set comprised of curved surfaces, linear surfaces, or any combination thereof, for example, such that a crest or distal portion of the thread comprises an increased size or dimension, relative to a horizontal plane that is perpendicular to the longitudinal axis of the dental implant and passes through the crest portion of the thread, when compared to a proximal portion of the thread (e.g., generally near the root of the thread). According to one example embodiment, a substantially uniform thread form comprising a feature set with curved surfaces, linear surfaces, or any combination thereof, is provided and helically extends along the elongate body 12. According to another example embodiment, multiple thread forms comprising a plurality of feature sets comprised of curved surfaces, linear surfaces, or any combination thereof, are provided and extend along the elongate body 12. In example embodiments, the feature sets, comprised of curved surfaces, linear surfaces, or any combination thereof, of the one or more threads 30 (e.g., having greater shape and dimension, relative to a horizontal plane that is perpendicular to the longitudinal axis of the dental implant and passes through the crest portion of the thread, at the distal portion of the thread than the proximal portion) preferably restrict the one or more threads 30 from moving proximally toward the center of the full or partial osteotomy, thereby restricting lateral movement and substantially stabilizing the implant 10 in three-dimensions within the full or partial osteotomy. Preferably, the one or more threads and feature sets comprised of curved surfaces, linear surfaces, or any combination thereof, can be configured as desired, for example, such that the larger size or dimension, relative to a horizontal plane that is perpendicular to the longitudinal axis of the dental implant and passes through the crest of the thread, at the crest portion of the one or more threads 30, restricts lateral movement and substantially stabilizes the implant 10 in three-dimensions within the full or partial osteotomy.

As described above, the one or more threads 30 comprise a feature set comprised of curved surfaces, linear surfaces, or any combination thereof, for example, such that a crest or distal portion of the thread comprises an increased size or dimension, relative to a horizontal plane that is perpendicular to the longitudinal axis of the dental implant and passes through the crest portion of the thread, when compared to a proximal portion of the thread (e.g., generally near the root of the thread). In example embodiments, the feature set can optionally be formed along a superior flank portion and/or an inferior flank portion, for example, in addition to one or more feature sets being formed along the root or crest portions. Thus, in example embodiments, the one or more threads 30 comprise a feature set comprised of curved surfaces, linear surfaces, or any combination thereof, formed along at least a portion of the root portion, crest portion, superior flank portion, inferior flank portion, or any combination thereof.

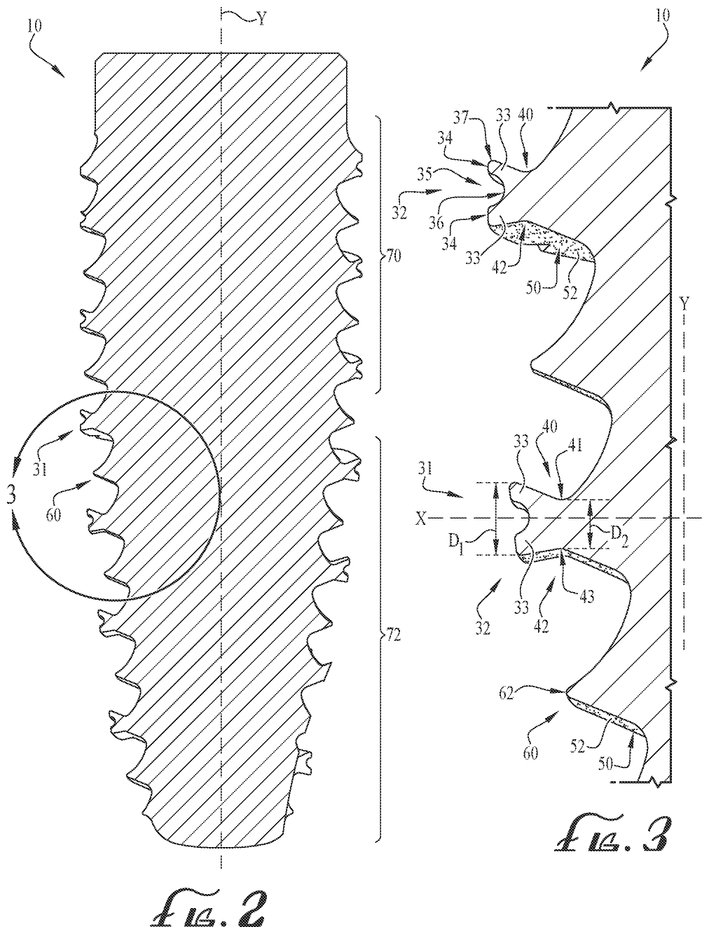

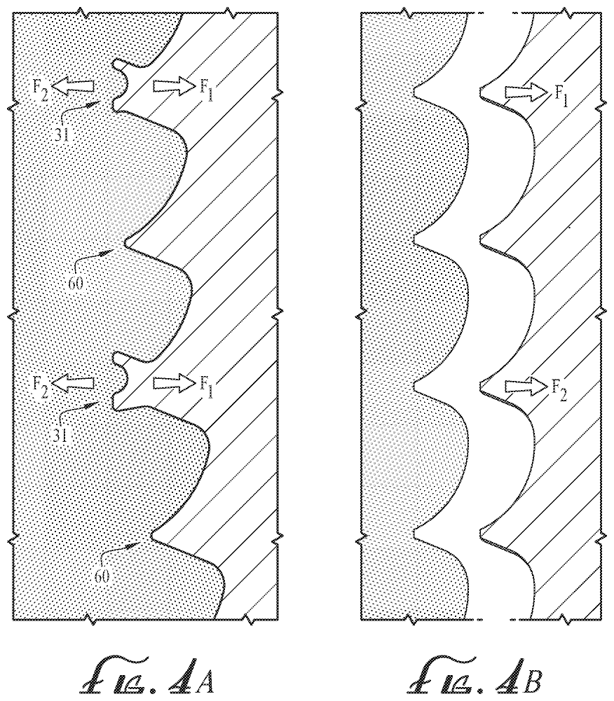

FIGS. 2-3 show the implant 10 in greater detail. In example embodiments, the implant 10 comprises a tapered body 12 defining a lateral portion 70 and an apical portion 72. In example embodiments, the tapered body 12 is preferably beneficial as the taper allows for the implant to improve its fitting with the anatomy of the maxillofacial bone. For example, in the case of either a full or partial osteotomy, the apical portion 72 along with the curved feature sets of the one or more threads (along the lateral portions, apical portions, or any combination thereof 70, 72) stabilizes the implant and maximizes the restriction of lateral movement of the implant 10 with the surrounding bone. In another example embodiment, in the case of a partial osteotomy (e.g., where portions of the implant become exposed or without a complete seal around the implant), the restriction of lateral movement caused by the one or more feature sets comprising of curved surfaces, linear surfaces, or any combination thereof, integrating with the surrounding bone substantially stabilizes the implant 10.

In example embodiments and as described above, the one or more threads 30 can be comprised of one or more feature sets comprising curved surfaces, linear surfaces, or any combination thereof, as desired. For example, as depicted in FIGS. 2-3, the implant 10 comprises a multi-lead thread with one or more threads 30 formed on the elongate body 12 between the first and second ends 14, 16, for example, which preferably assist in resisting or restricting lateral movement of the implant 10 within a full or partial osteotomy. In example embodiments, one or more thread forms on one or more multi-lead threads 30 comprise a feature set comprised of curved surfaces, linear surfaces, or any combination thereof, for example, such that a crest or distal portion of the thread, comprises an increased size or dimension, relative to a horizontal plane that is perpendicular to the longitudinal axis of the dental implant and passes through the crest portion of the thread, when compared to a proximal portion of the thread (e.g., generally near the root of the thread). According to one example embodiment, at least one substantially uniform thread form of the multi-lead threads comprises a feature set with curved surfaces, linear surfaces, or any combination thereof, is provided and helically extends along the elongate body 12 and comprises at least one of the multi-lead threads, the remaining threads being any standard threads (e.g. v-threads, buttress threads, etc.).

According to another example embodiment, at least one of the multiple thread forms of the multi-lead threads comprises a plurality of feature sets comprised of curved surfaces, linear surfaces, or any combination thereof, are provided and extend along the elongate body 12 and comprises at least one of the multi-lead threads, the remaining threads being any standard threads (e.g. v-threads, buttress threads, etc.). According to another example embodiment, at least two different threads of the multi-lead thread, individually comprising of a feature set of curved surfaces, linear surfaces, or any combination thereof, are combined to create a new feature set by the summation of the feature sets of the individual threads. In example embodiments, the feature sets, individual or combined, comprised of curved surfaces, linear surfaces, or any combination thereof, of the one or more threads 30 (e.g., having greater shape and dimension, relative to a horizontal plane that is perpendicular to the longitudinal axis of the dental implant and passes through the crest portion of the thread, at the distal portion of the thread than the proximal portion) preferably restrict the one or more threads 30 from moving proximally toward the center of the full or partial osteotomy, thereby restricting lateral movement and substantially stabilizing the implant 10 in three-dimensions within the full or partial osteotomy.

Preferably, the one or more threads and feature sets comprised of curved surfaces, linear surfaces, or any combination thereof, can be configured as desired, for example, such that the larger size or dimension, relative to a horizontal plane that is perpendicular to the longitudinal axis of the dental implant and passes through the crest of the thread, at the crest portion of the one or more threads 930, restricts lateral movement and substantially stabilizes the implant 900 in three-dimensions within the full or partial osteotomy.

For example, as shown in FIG. 3, the unique feature set 32 is generally provided at the crest or distal portion of the three-dimensional stabilization thread 31. In example embodiments, a larger shape or dimension D1, relative to a horizontal plane X that is perpendicular to the longitudinal axis Y of the dental implant (and passes through the crest portion of the thread) is present at a distal portion of the three-dimensional stabilization thread, and a smaller shape or dimension D2, relative to a horizontal plane X that is perpendicular to the longitudinal axis Y of the dental implant (and passes through the crest portion of the thread) is present at a proximal portion of the three-dimensional stabilization thread. As such, with the distal portion (near the crest) comprising the dimension D1, which is larger than the dimension D2 of the proximal portion (near the root), the implant is provided with stability and the restriction of lateral movement of the implant 10 with the surrounding bone is maximized.

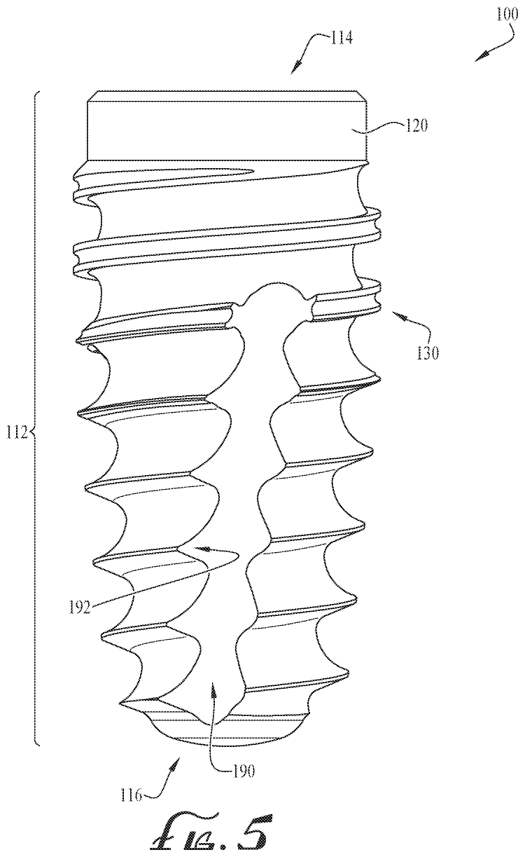

For example, as depicted in FIGS. 4A-B, a vector diagram of the retention forces of the three-dimensional stabilization thread form (see FIG. 4A) are compared to the lack of retentive forces of a standard thread (see FIG. 4B). In example embodiments and as depicted in FIG. 4A, a lateral force F₁ is applied on the implant 10 away from the full or partial osteotomy and a retentive force F₂ is applied by the bone of the full or partial osteotomy on the implant 10. Thus, the three-dimensional stabilization thread form 31 (and comprising a unique feature set) is configured such that the retentive force F₂ is applied by the bone of the full or partial osteotomy on the implant 10, thereby acting as a mechanical retention or friction retention feature to stabilize the implant 10. In contrast as depicted in FIG. 4B, the standard thread lacks a thread form to provide for three-dimensional stabilization, thereby not providing any mechanical retention or friction retention features to stabilize the implant.

Referring back to FIG. 3, the unique feature set 32 of the three-dimensional stabilization thread form 31 can comprises curved surfaces, linear surfaces, or any combination thereof, formed along at least a portion of the root portion, the crest portion, superior flank portion, inferior flank portion, or any combination thereof. According to one example embodiment, the unique feature set 32 is defined by an inferior flank portion 40 and a superior flank portion 42 and comprises a pair of projections or extensions 33 outwardly extending away from the root portion and a crest relief feature 35 formed generally between the extensions 33.

In example embodiments, the crest relief feature 35 comprises a non-linear or curved feature or surface 36, which is generally defined between the extensions 33 and can comprise a desirable depth, for example, such that the curved surface 36 of the crest relief feature 35 can be recessed a desired distance (from the distal end towards the root) between the extensions 33. According to example embodiments, each of the extensions 33 comprise an end surface 34, and corner portions of the extensions 33 comprise transitional edges 37, for example, which further extend to the inferior and superior flank portions 40, 42. According to other example embodiments, the crest relief feature need not have a curved surface 36, for example, but can instead have one or more linear surfaces, or any combination of curved and linear geometry.

For example, according to example embodiments of the invention, the distal end of the three-dimensional stabilization thread 31 defines the larger dimension D1, for example, which is generally defined between outermost end portions of the extensions 33, and the smaller dimension D2 is defined at a proximal portion of the three-dimensional stabilization thread 31 near the inferior and superior flank portions 40, 42 (see FIG. 3). According to example embodiments, a radiused or curved transition 41 is provided at the inferior flank portion 40 and a radiused or curved transition 43 is provided at the superior flank portion 42. According to alternate embodiments of the invention, so long as the larger dimension D1 is greater than the smaller dimension D2, the crest relief feature can comprise other desired shapes. According to one example embodiment, the crest relief feature 35 is preferably uniformly curved and generally centered to define an inwardly and radially extending surface between the extensions 33. According to example embodiments, the tapered standard threads 60 comprise a transitional edge 62 at the distal portion thereof.

According to example embodiments, after the implant 10 has been machined so as to define the multi-lead threads comprising the three-dimensional stabilization threads 31 and the tapered standard threads 60, the implant body 12 is further processed by a particle blast process. According to example embodiments, the particle blast process preferably rounds the edges of the three-dimensional stabilization threads 31 and the tapered standard threads 60 while also roughening/texturizing an outer surface of the implant 10 (and threads 31, 60 thereof). For example, as depicted in FIGS. 2-3, the end surfaces 34 and transitional edges 37, 62 are at least partially rounded such that a pointed or generally sharp edge is nonexistent, for example, so that no definite edge is defined between two converging surfaces along the threads 31, 60. Thus, according to example embodiments, after the particle blast process, the threads 31, 60 comprise rounded or generally curved edges defined along portions of the threads 31, 60.

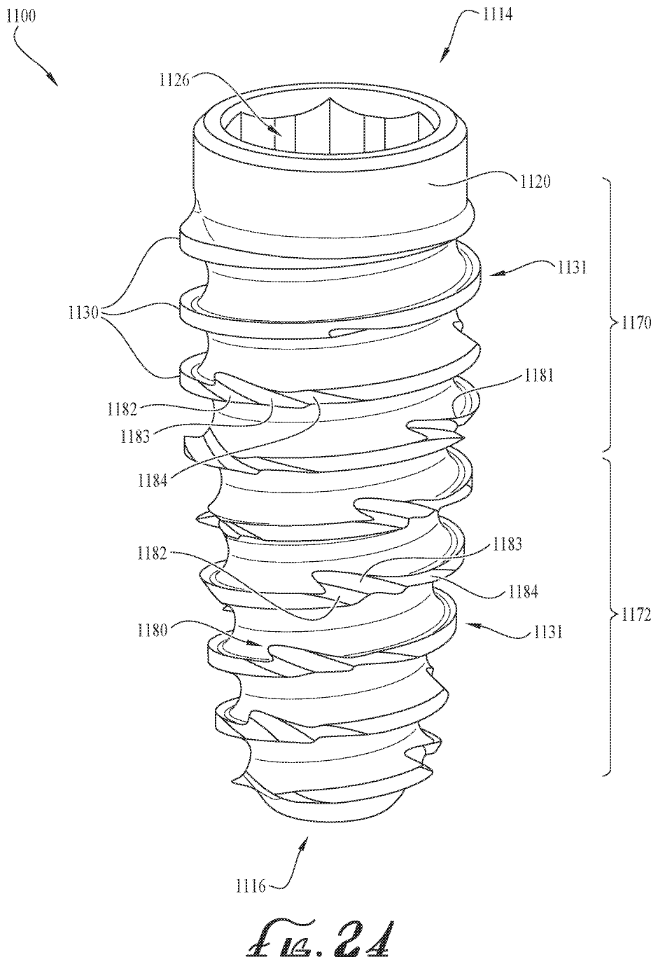

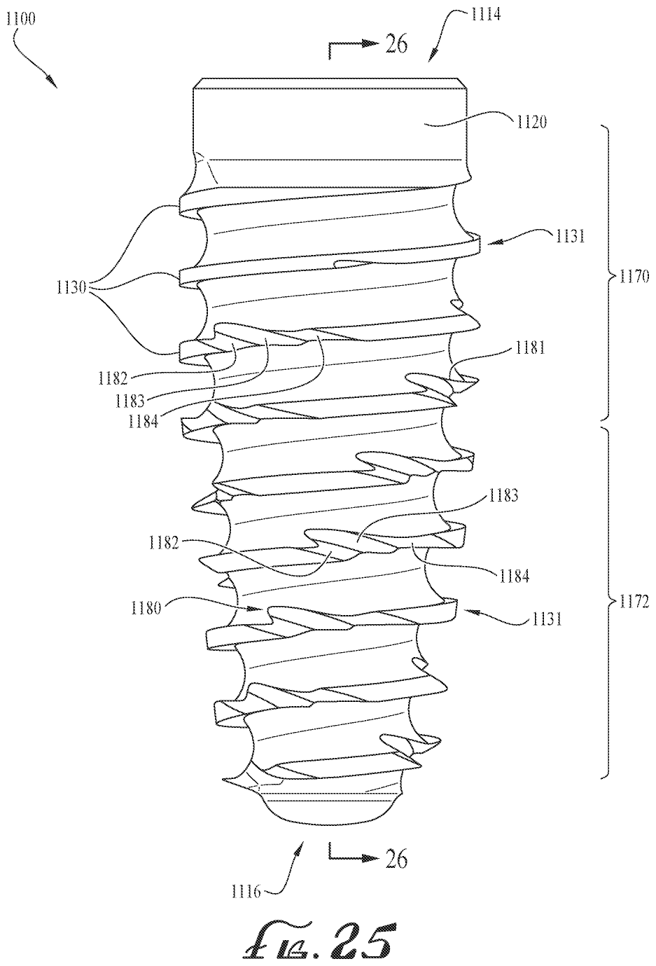

According to example embodiments, the particle blast process preferably roughens or texturizes the outer surface of the implant such that the osseointegration of the dental implant to the surrounding bone is improved. According to example embodiments and as best depicted in FIG. 3, an outer surface 50 of the implant comprises a roughened surface 52 (in Sa) of between about 0.5-4.0 μm. In alternate example embodiments, the roughened surface can preferably be chosen as desired, for example, less than 0.5 μm or greater than 4.0 μm (see also FIGS. 22-23).

Referring back to FIG. 1, the implant 10 can preferably comprise one or more self-tapping features or cutting flutes 90, for example, which can interrupt the threads 30 by extending along any desirable path or pattern (e.g., helical, linear, other desirable path or pattern) along the body 12. For example, a cutting flute 90 is depicted in FIG. 1, wherein the flute 90 generally extends along a helical path and defines a plurality of interruptions 92 with the threads 30. According to another example embodiment, the cutting flute 90 extends along a generally linear path and defines a plurality of interruptions 92.

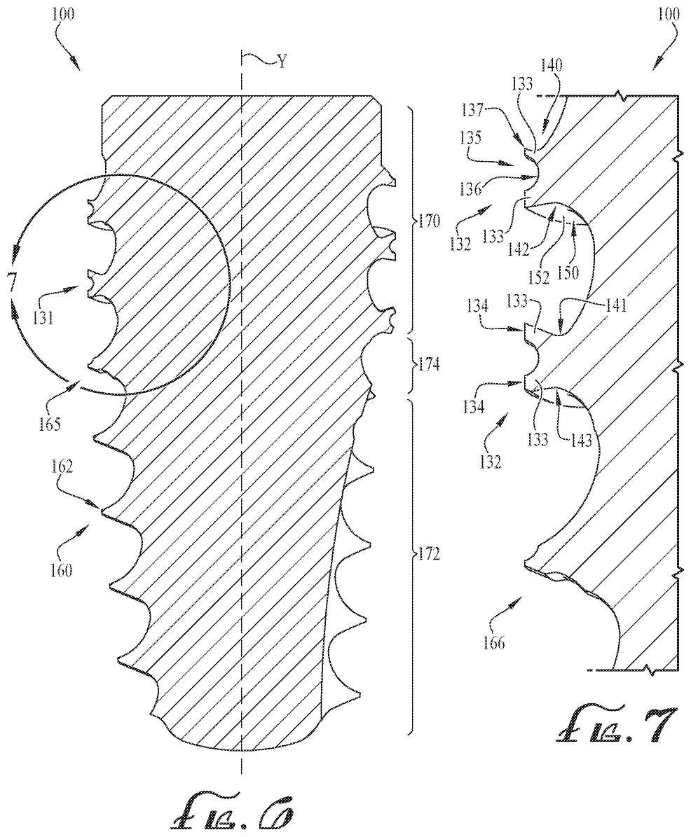

FIGS. 5-7 show an implant 100 according to another example embodiment of the present invention. According to example embodiments, the implant 100 is generally similar to the implant 10 described above, for example, comprising a lateral portion 170 and an apical portion 172 and comprising at least one three-dimensional stabilization thread form. In example embodiments, the implant 100 comprises threads 130 including a three-dimensional stabilization thread form 131 comprising a unique feature set 132 at the crest or distal portion of the thread, and the apical portion 172 of the body comprises tapered standard threads 160 (e.g., v-threads, buttress threads, etc.). According to example embodiments, a transition portion 174 defines a thread form transition zone 165. In example embodiments, a transition thread form 165 is defined between the tapered standard threads 160 (e.g., v-threads, buttress thread, etc.) and the three-dimensional stabilization thread form 131.

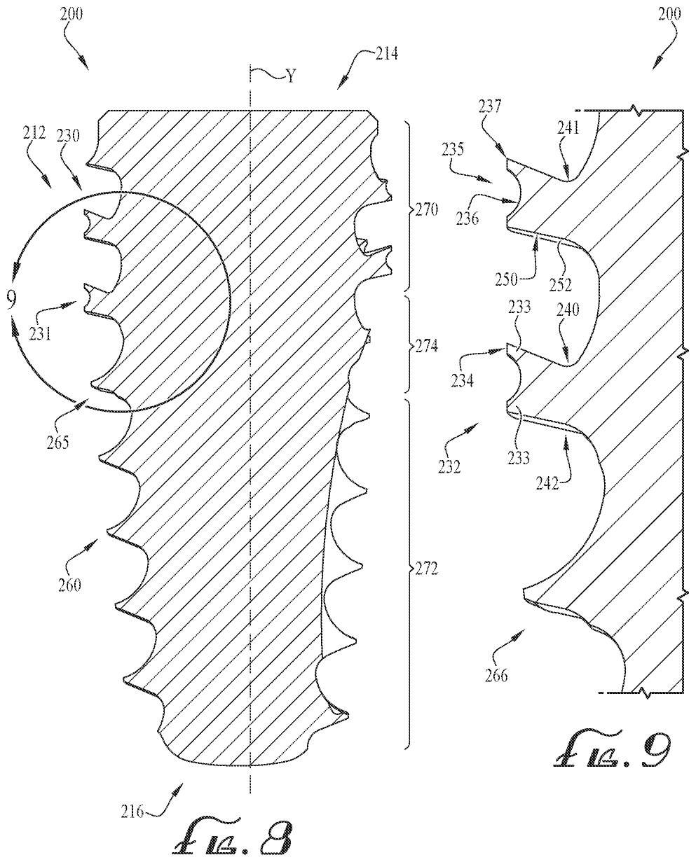

As depicted in FIGS. 6-7, the three-dimensional thread form 131 comprises the unique feature set 132 at the crest or distal portion of the thread. According to one example embodiment, a crest relief feature 135 is provided, for example, which can comprise curved, linear, or any combination of curved and linear geometry. As depicted in FIG. 7 and according to one example embodiment, the crest relief feature 135 comprises a nonlinear or curved feature or surface 136 formed at the crest or distal portion of the thread.

According to one example embodiment as similarly described above with respect to the implant 10, the unique feature set 132 is defined by an inferior flank portion 140 and a superior flank portion 142, and the crest relief feature is formed at the distal portion thereof such that a pair of extensions 133 are defined so as to outwardly extend away from the root portion (and each other).

In example embodiments, the crest relief feature 135 comprises a non-linear or curved feature or surface 136, which is generally defined between the extensions 133 and can comprise a desirable depth, for example, such that the curved surface 136 of the crest relief feature 135 can be recessed a desired distance (from the distal end towards the root) between the extensions 133. According to example embodiments, each of the extensions 133 comprise an end surface 134, and corner portions of the extensions 133 comprise transitional edges 137, for example, which further extend to the inferior and superior flank portions 140, 142. According to other example embodiments, the crest relief feature need not have a curved surface, for example, but can instead have one or more linear surfaces, or any combination of curved and linear geometry.

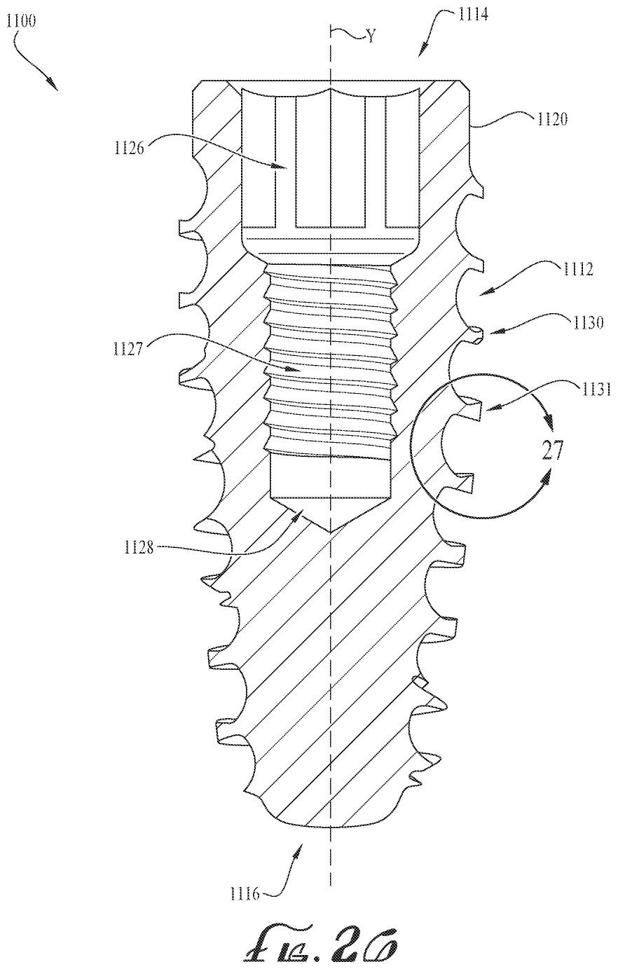

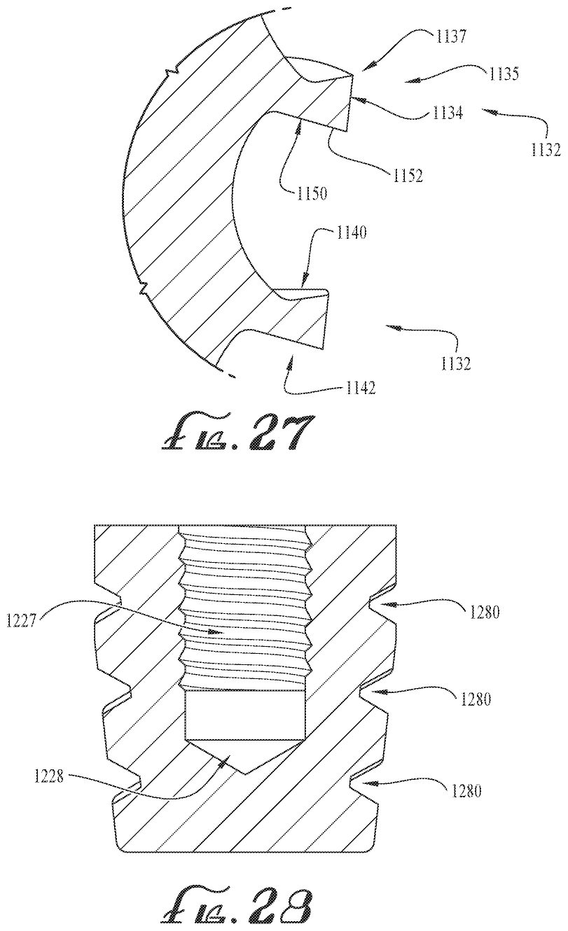

As similarly described above, after the implant 100 has been machined so as to define the threads 130 comprising the three-dimensional stabilization threads 131 and the tapered standard threads 160, the implant body 112 is further processed by a particle blast process. As depicted in FIGS. 2-3, the threads 30 formed on the body 12 are depicted according to post particle blast process (e.g., with roughened surface and rounded transitional edges). As is depicted throughout FIGS. 5-22 and 24-29, the body and thread forms thereof are depicted according to their shape and geometry after being machined but before the particle blast process. Accordingly, as will be described herein, while the embodiments of FIGS. 5-29 do not include the resulting rounding and roughening of the particle blast process, it is to be understood that the particle blast process may be provided after the implant has been machined. Accordingly, according to one example embodiment of the present invention, the particle blast process is provided for each of the embodiments of FIGS. 1-29, and the resulting form preferably comprises rounded edges or transitions and an outer surface of the body (and threads thereof) comprises a roughened surface. According to example embodiments, an outer surface 150 of the implant comprises a roughened surface 152 (in Sa) of between about 0.5-4.0 μm. In alternate example embodiments, the roughened surface can preferably be chosen as desired, for example, less than 0.5 μm or greater than 4.0 μm (see also FIGS. 22-23).

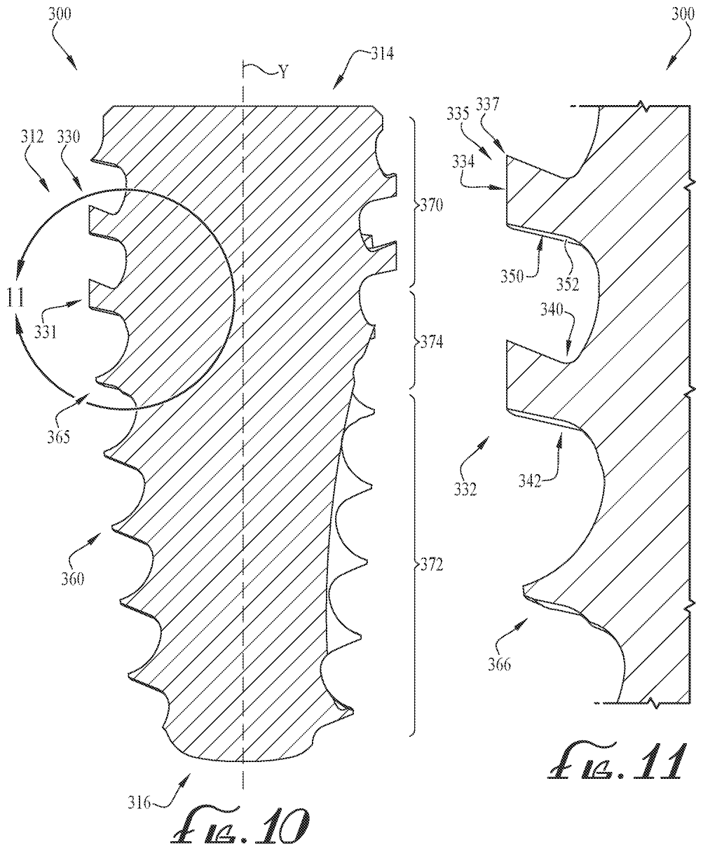

FIGS. 8-9 show an implant 200 according to another example embodiment of the present invention. According to example embodiments, the implant 200 is generally similar to the implants 10, 100 described above, for example, comprising a lateral portion 270 and an apical portion 272 and comprising at least one three-dimensional stabilization thread form. In example embodiments, the implant 200 comprises threads 230 including a three-dimensional stabilization thread form 231 comprising a unique feature set 232 at the crest or distal portion of the thread. In example embodiments, the three-dimensional stabilization thread form 231 is provided at the lateral portion 270, and the apical portion 272 of the body 212 comprises tapered standard threads 260 (e.g., v-threads, buttress threads, etc.). According to example embodiments, a transition portion 274 defines a thread form transition zone 265. In example embodiments, a transition thread form 266 is defined between the tapered standard threads 260 (e.g., v-threads, buttress thread, etc.) and the three-dimensional stabilization thread form 231.

In example embodiments, the three-dimensional thread form 231 comprises the unique feature set 232 at the crest or distal portion of the thread. According to one example embodiment, a crest relief feature 235 is provided, for example, which can comprise curved, linear, or any combination of curved and linear geometry. As depicted in FIG. 9 and according to one example embodiment, the crest relief feature 235 comprises a nonlinear or curved feature or surface 236 formed at the crest or distal portion of the thread.

According to one example embodiment as similarly described above with respect to the implant 10, 100, the unique feature set 232 is defined by an inferior flank portion 240 and a superior flank portion 242, and the crest relief feature is formed at the distal portion thereof such that a pair of extensions 233 are defined so as to outwardly extend away from the root portion.

In example embodiments, the crest relief feature 235 comprises a non-linear or curved feature or surface 236, which is generally defined between the extensions 233 and can comprise a desirable depth, for example, such that the curved surface 236 of the crest relief feature 235 can be recessed a desired distance (from the distal end towards the root) between the extensions 233. According to example embodiments, each of the extensions 233 comprise an end surface 234, and corner portions of the extensions 233 comprise transitional edges 237, for example, which further extend to the inferior and superior flank portions 240, 242. According to other example embodiments, the crest relief feature need not have a curved surface, for example, but can instead have one or more linear surfaces, or any combination of curved and linear geometry.

As similarly described above, after the implant 200 has been machined so as to define the threads 230 comprising the three-dimensional stabilization threads 231 and the tapered standard threads 260, the implant body 212 can be further processed by a particle blast process. According to one example embodiment, the implant 200 is provided with a post-machining particle blast process. The resulting form preferably comprises rounded edges or transitions and an outer surface of the body (and threads thereof) comprises a roughened surface. According to example embodiments, an outer surface 250 of the implant comprises a roughened surface 252 (in Sa) of between about 0.5-4.0 μm. In alternate example embodiments, the roughened surface can preferably be chosen as desired, for example, less than 0.5 μm or greater than 4.0 μm (see also FIGS. 22-23).

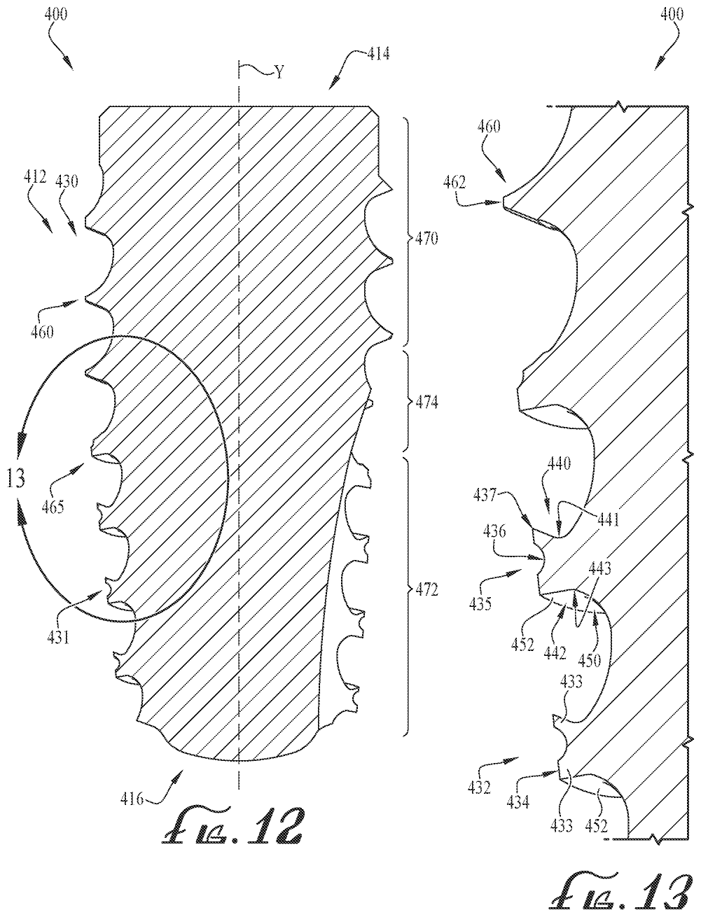

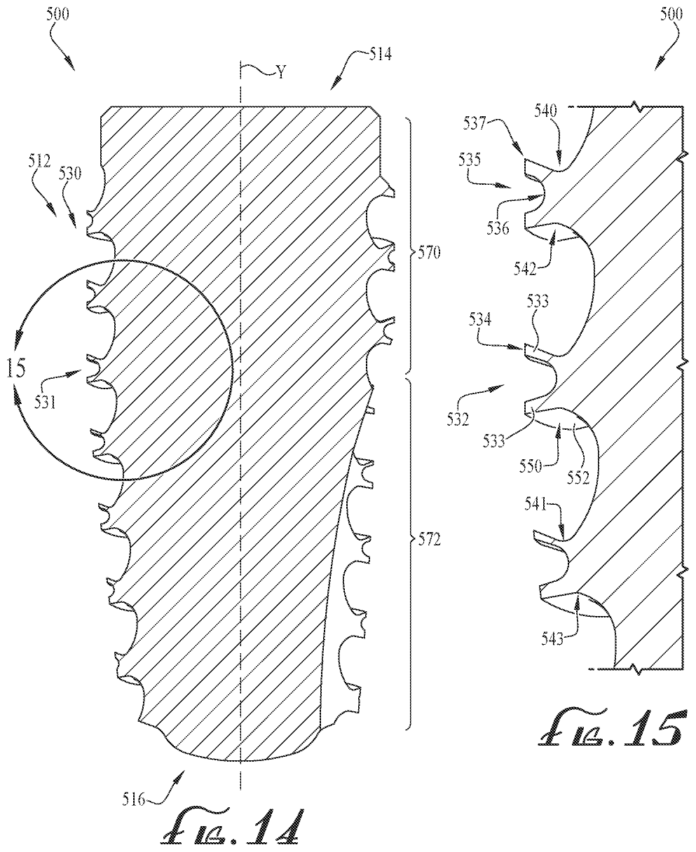

FIGS. 10-11 show an implant 300 according to another example embodiment of the present invention. According to example embodiments, the implant 300 is generally similar to the implants 10, 100, 200 described above, for example, comprising a lateral portion 370 and an apical portion 372 and comprising at least one three-dimensional stabilization thread form. In example embodiments, the implant 300 comprises threads 330 including a three-dimensional stabilization thread form 331 comprising a unique feature set 332 at the crest or distal portion of the thread. In example embodiments, the three-dimensional stabilization thread form 331 is provided at the lateral portion 370, and the apical portion 372 of the body 312 comprises tapered standard threads 360 (e.g., v-threads, buttress threads, etc.). According to example embodiments, a transition portion 374 defines a thread form transition zone 365. In example embodiments, a transition thread form 366 is defined between the tapered standard threads 360 (e.g., v-threads, buttress thread, etc.) and the three-dimensional stabilization thread form 331.

According to example embodiments, the three-dimensional thread form 331 comprises the unique feature set 332 at the crest or distal portion of the thread. According to one example embodiment, a crest feature is provided, for example, which comprises a generally linear surface 334. For example, rather than the curved crest relief feature 236 of the implant 200, the crest feature 334 generally comprises a linear surface feature, for example, without any relief feature. Optionally, the crest feature 334 can comprise curved, linear, or any combination of curved and linear geometry.

According to example embodiments, the implant 300 is substantially similar to the implant 200, for example, except that the implant 300 does not have a crest relief feature. Accordingly, as similarly described above, the implant 300 can comprise rounded edges and transitions and a roughened outer surface (e.g., by undergoing a particle blast process).

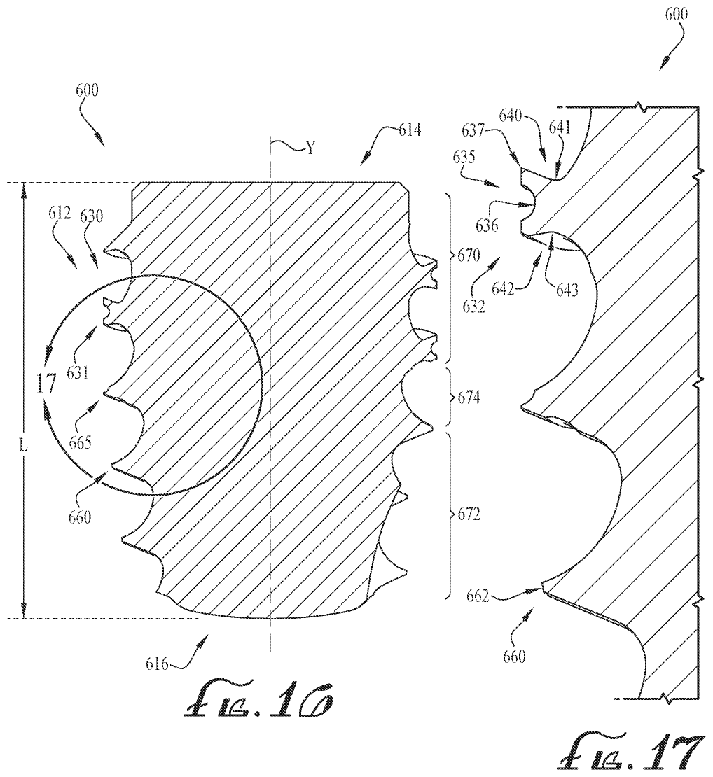

FIGS. 12-13 show an implant 400 according to another example embodiment of the present invention. As depicted, the implant 400 is generally similar to the implant 100 as described above, however the apical portion 472 has a three-dimensional stabilization thread form 431 with a unique feature set 432 at the crest or distal portion of the thread, wherein the lateral portion 470 of the body 412 comprises tapered standard threads 460 (e.g., v-threads, buttress threads, etc.), and wherein the transition portion 474 defines a thread form transition zone 465. According to example embodiments, the unique feature set 432 is generally similar to the unique feature sets 10, 100 as described above.

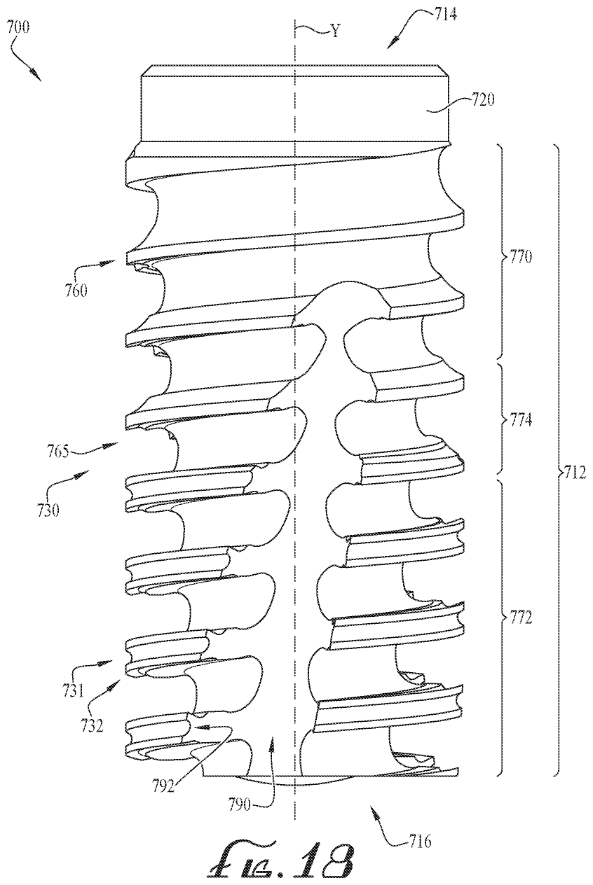

FIGS. 14-15 show an implant 500 according to another example embodiment of the present invention. As depicted, the implant 500 is generally similar to the implant 100 as described above, however both the lateral portion 570 and the apical portion 572 have a continuous three-dimensional stabilization thread form 531 comprising a unique feature set 532 at the crest or distal portion of the thread. According to example embodiments, the unique feature set 532 is generally similar to the unique feature sets 10, 100 as described above.

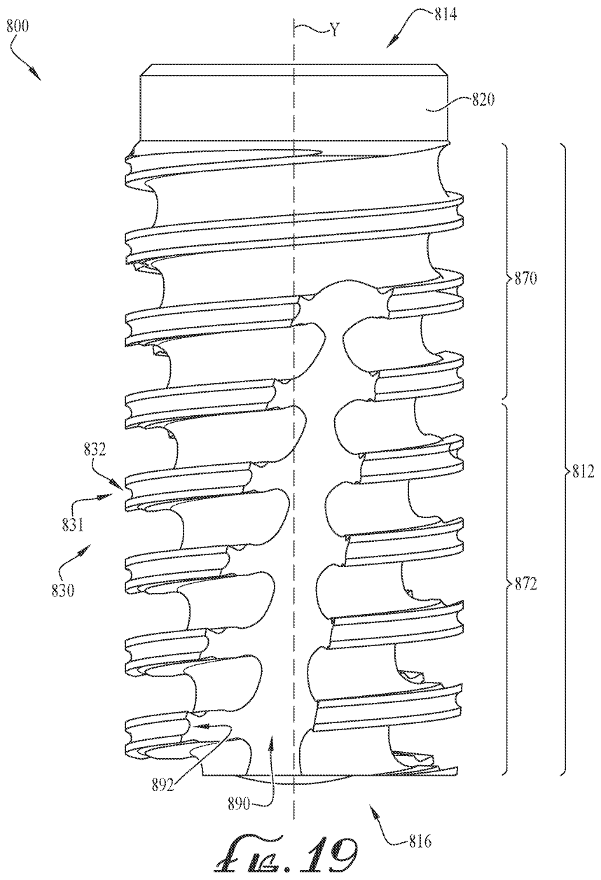

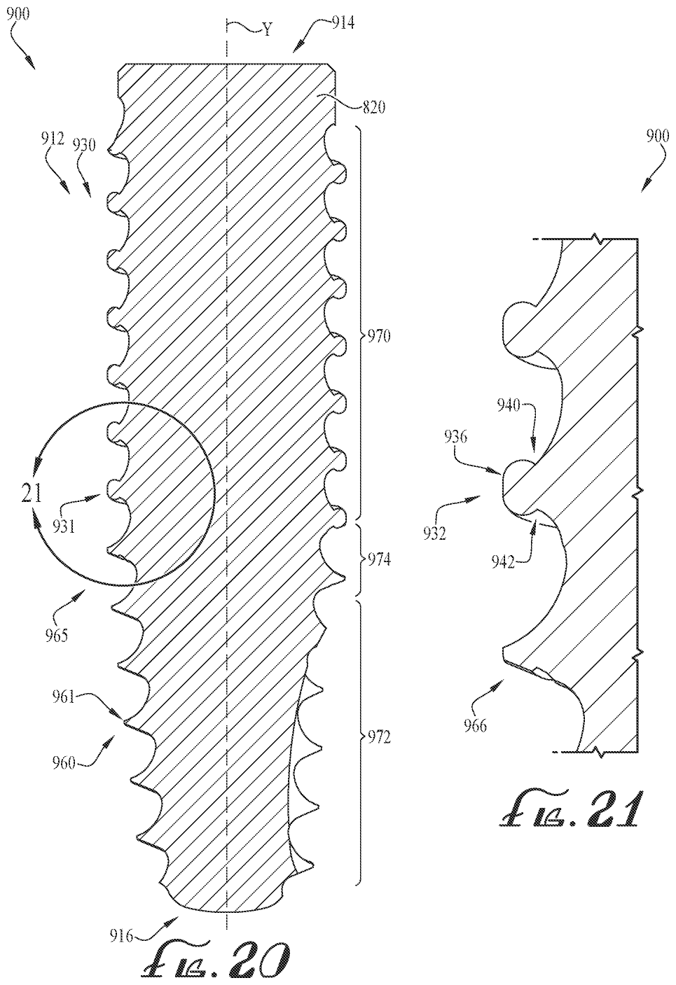

FIGS. 16-17 show an implant 600 according to another example embodiment of the present invention. As depicted, the implant 600 is generally similar to the implant 100 as described above, for example, comprising the lateral portion 670 having a three-dimensional stabilization thread form 631 comprising a unique feature set 632 at the crest or distal portion of the thread, wherein the apical portion 672 of the body 612 comprises tapered standard threads 660 (e.g., v-threads, buttress threads, etc.), and wherein the transition portion 674 defines a thread form transition zone 665. According to example embodiments, the implant 600 an overall length L of less than or equal to 8 millimeters. According to another example embodiment, the length L is about 8 millimeters or greater, for example, which is generally depicted in FIGS. 5-7. According to example embodiments, the unique feature set 632 is generally similar to the unique feature sets 10, 100 as described above.

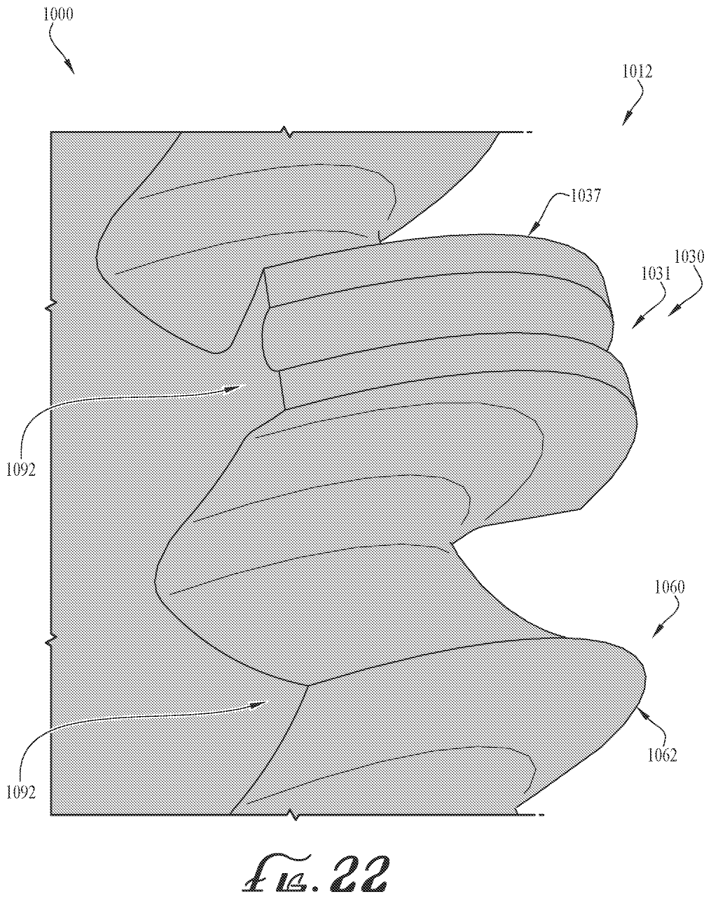

FIGS. 18-19 show implants 700, 800 according to additional example embodiments of the present invention. FIG. 18 shows the implant 700, for example, which has an overall tapered body 712 with one or more thread forms and/or one or more thread leads that remain parallel and do not taper with the body of the implant. The implant 700 is similar to the implant 400, as described above, in that the apical portion 772 has a three-dimensional stabilization thread form 731 with a unique feature set 732 at the crest or distal portion of the thread, wherein the lateral portion 770 of the body 712 comprises tapered standard threads 760 (e.g., v-threads, buttress threads, etc.), and wherein the transition portion 774 defines a thread form transition zone 765. According to example embodiments, the unique feature set 732 is generally similar to the unique feature sets 10, 100 as described above. FIG. 19 shows the implant 800, which is generally similar to the implant 700 as described above, for example, having an overall tapered body with one or more thread forms and/or one or more thread leads that remain parallel and do not taper with the body of the implant. The implant 800 is similar to the implant 500, as described above, in that both the lateral portion 870 and the apical portion 872 have a continuous three-dimensional stabilization thread form 831 comprising a unique feature set 832 at the crest or distal portion of the thread.

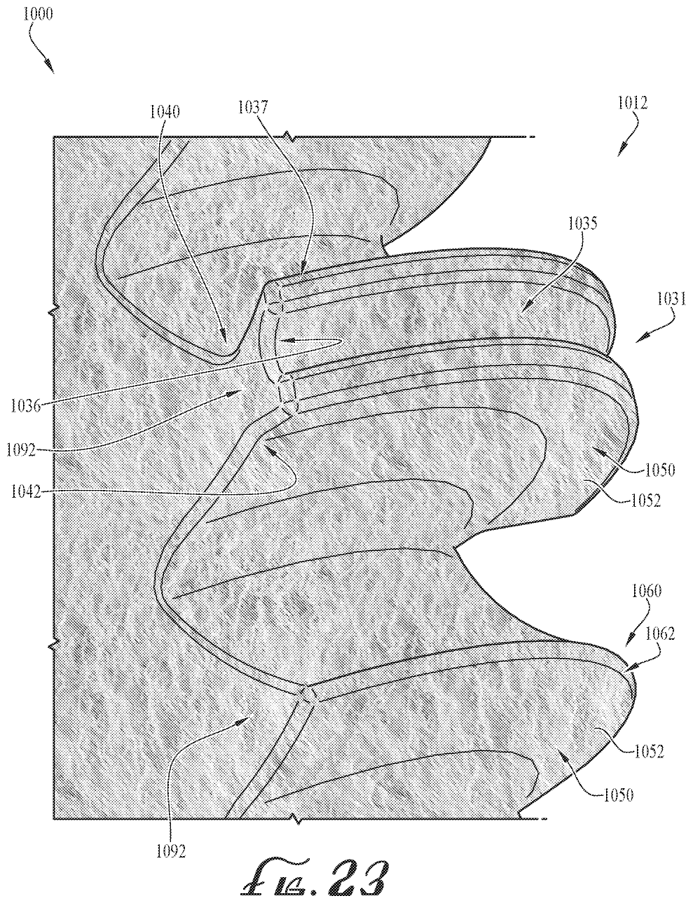

FIGS. 20-21 show an implant 900 according to another example embodiment of the present invention. As depicted, the implant 900 is generally similar to the implant 100 as described above, for example, comprising a body 912 comprising threads 930. In example embodiments, the threads 30 can comprise one or more feature sets comprising curved surfaces, linear surfaces, or any combination thereof, as desired. As shown in FIG. 20, a lateral portion 970 of the body 912 comprises a three-dimensional stabilization thread form 931 comprising a unique feature set 932 at the crest or distal portion of the thread 930. An apical portion 972 of the body 912 comprises tapered standard threads 960 (e.g., v-threads, buttress threads, etc.), and a transition portion 974 defines a thread form transition zone 965 comprising a standard thread 966 (e.g., v-threads, buttress thread, etc.). According to example embodiments, the unique feature set 932 comprises an inferior and superior portion 940, 942 defining a smaller dimension, and wherein a radiused surface 936 is defined at a crest or distal portion of the thread 931 to define a larger dimension, for example, as similarly described with respect to the three-dimensional stabilization thread forms of the implants 10, 100.

FIGS. 22-23 show an implant 1000 according to another example embodiment of the present invention. For example, as described above, after the implant 10 has been machined so as to define the multi-lead threads comprising the three-dimensional stabilization threads 1031 and the tapered standard threads 1060 (or various other thread forms as described herein), the implant body 1012 is further processed by a particle blast process. For example, the implant 1000 of FIG. 22 shows the transitional edges 1037, 1060 and the leading edges 1092 (defined by the cutting flute) having substantially defined edges and intersections between the feature sets of the threads 1030. However, after completion of the particle blast process, the transitional edges 1037, 1060, leading edges 1092 (any any other defined intersections or edges) of the threads 1030 are preferably rounded. Furthermore, an outer surface 1050 of the threads 1030 comprises a roughened surface 1052, for example, which is preferably present about the entirety of the outer surface of the 1050 of the body 1012. According to example embodiments, the particle blast process preferably roughens or texturizes the outer surface of the implant such that the osseointegration of the dental implant to the surrounding bone is improved. According to example embodiments and as best depicted in FIG. 23, an outer surface 1050 of the implant body 1012 comprises a roughened surface 1052 (in Sa) of between about 0.5-4.0 μm. In alternate example embodiments, the roughened surface can preferably be chosen as desired, for example, less than 0.5 μm or greater than 4.0 μm.

As similarly described above, the one or more threads 30, 130, 230, 330, 430, 530, 630, 730, 830, 930, 1030 of the implants 10, 100, 200, 300, 400, 500, 600, 700, 800, 900, 1000 can comprise a feature set on one or more leads, comprised of curved surfaces, linear surfaces, or any combination thereof, formed along at least a portion of the root portion, crest portion, superior flank portion, inferior flank portion, or any combination across any and all thread leads thereof. In example embodiments and as similarly described above, the implants 10, 100, 200, 300, 400, 500, 600, 700, 800, 900, 1000 can comprise one or more self-tapping cutting flutes extending along the body and forming interruptions with the one or more threads. Optionally, according to other example embodiments of the present invention, the implants 10, 100, 200, 300, 400, 500, 600, 700, 800, 900, 1000 can comprise a desirable length, and other dimensional attributes of the implant, thread forms, unique feature sets, cutting flutes, etc. can be chosen as desired. Preferably, the one or more threads, thread forms, unique feature sets, etc. as described herein can be sized and shaped as desired, for example, to provide for maximizing the restriction of lateral movement of the implant within the full or partial osteotomy. According to some example embodiments, the implants 10, 100, 200, 300, 400, 500, 600, 700, 800, 900, 1000 comprise a tapered body comprising multiple thread forms, for example, a three-dimensional stabilization thread form and a standard thread (e.g., v-thread, buttress thread, etc.) form on single or multi-leads.

According to another example embodiment, the present invention comprises a method of manufacturing an implant comprising at least one three-dimensional stabilization thread form. In example embodiments, the method includes providing a tapered implant body; machining one or more threads along the tapered body, the one or more threads comprising a three-dimensional stabilization thread form; and treating the entirety of the body and one or more threads with a particle blast process. According to example embodiments, the particle blast process preferably roughens or texturizes the outer surface of the implant such that the osseointegration of the dental implant to the surrounding bone is improved. According to example embodiments, an outer surface of the implant body comprises a roughened surface (in Sa) of between about 0.5-4.0 μm. In alternate example embodiments, the roughened surface can preferably be chosen as desired, for example, less 0.5 μm than or greater than 4.0 μm. According to example embodiments, any edges defined along one or more portions of the body (and one or more threads thereof) are substantially rounded.

FIGS. 24-30 show an implant 1100 according to another example embodiment of the present invention. According to example embodiments, the implant 1100 is generally similar to the implant 300 described above, for example, comprising a lateral portion 1170 and an apical portion 1172 and comprising at least one three-dimensional stabilization thread form. In some example embodiments, the implant body, thread-forms, and/or other features may comprise geometries, dimensions, materials, and/or other characteristics substantially as disclosed herein with respect to any of the previously described example embodiments. In example embodiments, the implant 1100 comprises one or more threads 1130 at least partially including a three-dimensional stabilization thread form 1131 comprising a unique feature set 1132 at the crest or distal portion of the thread. According to one example embodiment, a crest feature 1135 is provided, for example, which comprises a generally linear surface 1134. For example, rather than the curved crest relief feature 236 of the implant 200, the crest feature 1135 generally comprises a linear surface feature, for example, without any relief feature. Optionally, the crest feature 1135 can comprise curved, linear, or any combination of curved and linear geometry. According to one example embodiment, as similarly described above with respect to the implant, 10, 100, the unique feature set 1132 is further defined by an inferior flank portion 1140 and a superior flank portion 1142. In example embodiments, the crest feature 1135 may further comprise transitional edges 1137, for example, which extends to the inferior and superior flank portions 1140 and 1142.

In other embodiments, as previously described, the implant may include one or more thread forms on one or more multi-lead threads, which may comprise one or more feature sets of curved surfaces, linear surfaces, or a combination thereof, for example, such that a crest or distal portion of the thread comprises an increased size or dimension, relative to a horizontal plane that is perpendicular to the longitudinal axis of the dental implant and passes through the crest portion of the thread, when compared to a proximal portion of the thread (e.g., generally near the root of the thread). According to one example embodiment, at least one substantially uniform thread form of the multi-lead threads comprises a feature set with curved surfaces, linear surfaces, or any combination thereof, is provided and helically extends along the body and comprises at least one of the multi-lead threads, the remaining threads being any standard threads (e.g., v-threads, buttress threads, etc.). In further embodiments, the implant may have more than one taper along its body, or no taper at all along the body. The external thread(s) 1130 of the implant 1100 extend along one or more first helical paths or first helixes extending around the longitudinal axis Y and along at least a portion of the external surface of the implant in a first helical direction (e.g., a “right-hand” helical thread direction or “forward helix,” wherein clockwise (viewed from the top 1114) twisting or turning of the implant engages the threads with bone tissue to implant or embed the implant during the implant placement procedure. In some example embodiments, the threads 1130 have a thread pitch of between about 0.03″ to about 0.05″, for example about 0.04″, and a transverse thread crest dimension of between about 0.006″ to about 0.011″.

In some embodiments, the implant 1100 comprises an upper cylindrical portion 1120 defining an abutment receiver for receiving an abutment and abutment screw. In example embodiments, the implant 1100 has a hexagonal receiver 1126. The hexagonal receiver 1126 may be used to connect the blank implant to a mount for machining and may be used to connect the implant to a drill, wrench, abutment, or other tools or components for insertion and surgical implantation, and/or for attachment of a prosthetic tooth. In some embodiments, the implant 1100 comprises a threaded interior section 1127 and a conical bottom interior section 1128 for receiving an abutment screw for attachment of a prosthetic tooth.

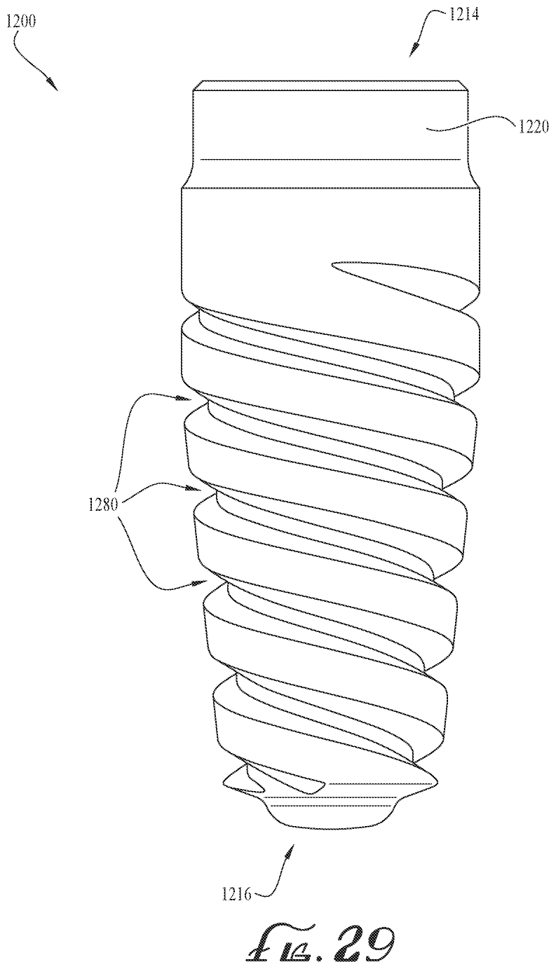

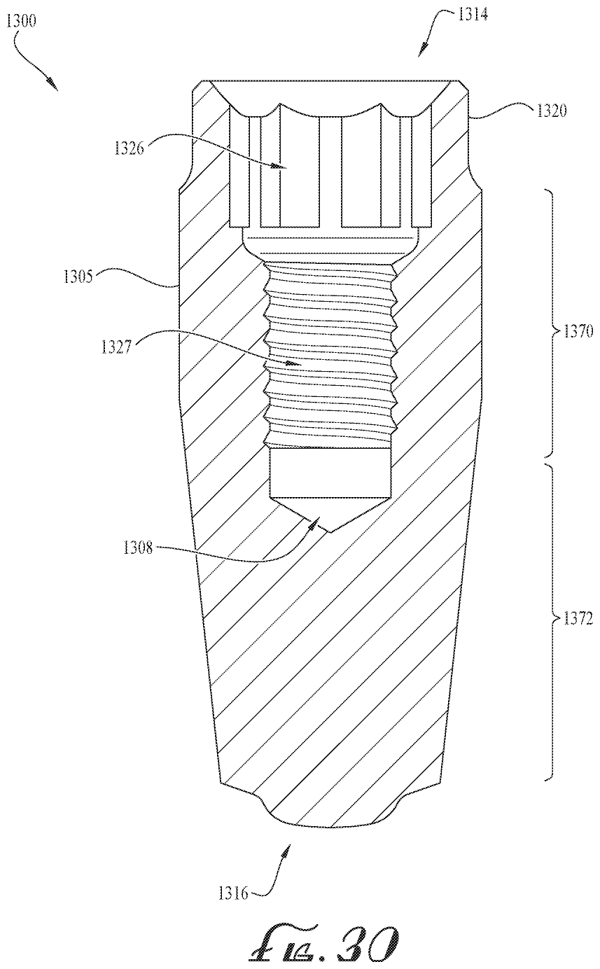

The implant 1100 may further comprise one or more cutting elements arranged along one or more cutting flutes, grooves or channels extending through the external threads 1130, extending along one or more second helical paths or second helixes extending around the longitudinal axis Y and along at least a portion of the external surface of the implant in a second helical direction generally opposite the first helical direction (e.g., a “left-hand” helical direction or “reverse helix,” opposite the right-hand direction or forward helix of the external threads 1130). In some particular example embodiments, a dual-lead configuration is provided with two second helix cutting channels or flutes 1180 running in the opposite direction of the three-dimensional thread 1130. In further embodiments, one, two, three or more reverse helix cutting channels or flutes 1180 are provided. In some example embodiments, the one or more reverse helix cutting channels or flutes 1180 are cut at approximately the same depth as the thread 1130. In other embodiments, the one or more second helix channels or flutes 1180 may be cut to a depth that is equal to, greater than, or less than the depth of the thread 1130. For example, the second helixes 1180 may be cut to a depth that is up to 50% greater than the depth of the threads 1130, or to a depth that is up to 50% less than the depth of the threads 1130. The second helixes 1180 can be seen more clearly in FIG. 28 and FIG. 29 in which the helical thread has been omitted (or not yet formed) for clarity, showing only the second helixes 1280 along the surface of the implant. In some example embodiments, the second helixes of the one or more cutting flutes, grooves or channels have a thread pitch of between about 0.02″ (0.5 mm) to about 0.08″ (2 mm), for example about 0.05″, about a 0.100″ left hand thread lead, and about a 60° thread angle. In some embodiments, the helical directions of the one or more threads 1130 and the one or more cutting grooves, flutes or channels 1180 may be switched or reversed, such that the one or more threads are left-handed or reverse helical direction threads, and the one or more cutting grooves, flutes or channels are arranged in a right-handed or forward helical direction.

When the channels, grooves, or flutes of the one or more second helixes 1180 are cut onto the implant 1100 across and through the one or more threads 1130 (or alternatively when the one or more threads 1130 are cut across and through the second helixes 1180, depending on the sequence of the fabrication method), it leaves interfaces forming spaced out or spaced apart trailing faces 1182, recessed faces 1183, and clearance faces 1184 along and within the threads 1130 along the side edges of the second helix 1180. The recessed faces 1183 are cut to approximately the same depth as the threads 1130. Cutting edges or cutting elements 1181 are formed between the clearance faces 1184 and the inferior flanks 1140 when the second helixes 1180 are cut into the body of the implant 1100 and are contiguous with the one or more helical threads 1130. In some embodiments, the thread 1130 has a chamfer adjacent the cutting edge. The chamfer makes contact with the bone following the cutting edge 1181 during implantation of the implant in the jaw of a patient. The channels or flutes of the second helixes 1180, in addition to creating the cutting edge or element 1181, also serve to assist in clearing bone debris created by the cutting edge or element during implantation, thereby assisting with implant placement.

In example embodiments, the implant is used in a conventional manner. The dentist or surgeon will drill a pilot hole for the implant. The implant is attached to an insertion tool and turned into the pilot hole. Upon turning, the cutting edges 1181 will cut grooves into the bone into which the thread 1130 will follow. The debris is pushed towards the first end 1114 of the body through the channels, grooves, or flutes of the second helixes 1180. This movement of debris keeps the pilot hole relatively free from debris thereby preventing debris from filling the pilot hole or binding or jamming the implant. This reduces incidences of the implant prematurely bottoming out in the pilot hole because of debris filling the hole and reduces the debris caught in the helical groove thereby reducing friction on the cutting surfaces, which reduces the torque required for insertion and placement of the implant.

FIG. 30 shows an implant body or blank 1300 (also referred to as stock) before either threads or a second helix have been cut into or otherwise added to the implant. In certain embodiments, the blank implant 1300 comprises a first end 1314, a second end 1316, a lateral portion 1370, and an apical portion 1372. The blank implant 1300 may have an upper cylindrical portion 1320 defining an abutment receiver for receiving an abutment and abutment screw. In example embodiments, the implant blank 1300 has a hexagonal receiver 1326. The hexagonal receiver 1326 may be used to connect the implant blank to a mount for machining and may later be used to connect the finished implant to a drill, wrench, or other application device, or to connect an abutment and prosthetic tooth to the implant. In some embodiments, implant blank 1300 comprises a threaded interior section 1327 and a conical bottom interior section 1308 for receiving an abutment screw.

In example embodiments, the implant can be manufactured from any structural material suitable for dental implants, including but not limited to stainless steels, titanium, ceramics, polymers, alloys, and any other material(s) with appropriate mechanical characteristics, which is biocompatible. In example embodiments, the implants can be readily manufactured using a modem lathe capable of cutting screw threads. The unfinished stock is mounted in the lathe at the first end. The cutting blade of the lathe cuts a helical groove in a first helical direction in the stock leaving the desired primary external thread. The direction of rotation is then changed, and the desired secondary helical grooves are cut in a second, generally opposite, helical direction, across the primary thread thereby creating the cutting surfaces. Alternatively, the fabrication sequence may be reversed, first forming the secondary helical grooves in the blank, and then forming the external threads. The shape of the helices is determined by the cutting head on the lathe and different cutting heads can be used to create different helices. It will be appreciated that both straight and tapered implants can be created in this manner. It will also be appreciated that that any number of threads and secondary helixes can be created in this manner.

Alternatively, depending on the manufacturing materials, the implant can be formed by passing the stock comprising the body through one or more cutting dies as is known in the art or by the use of molds or forging. For implants made of plastics, ceramics or polymers, molding may be the preferred method of manufacture. As long as the properties of the implant materials are taken into account, any thread pitch, thread thickness, thread form, and/or cutting element configurations are possible up to the point where the material is too thin to support the load placed on it. Threads and cutting edges that are too thin may break under higher torques or distort during insertion. As similarly described above, after the implant 1100 has been machined so as to define the threads 1130 comprising the three-dimensional stabilization threads 1131 and secondary helix 1180, the implant 1100 may optionally be further processed by a particle blast process. According to particular example embodiments, the resulting thread form may comprise rounded edges or transitions and an outer surface of the body (and threads thereof) comprise a roughened surface. According to further example embodiments, an outer surface 1150 of the implant 1100 comprises a roughened surface 1152 (in Sa) of between about 0.5-4.0 μm. In alternate example embodiments, the roughened surface can preferably be chosen as desired, for example, less than 0.5 μm or greater than 4.0 μm (see also FIGS. 22-23).

In some particular example embodiments, the threads 1130 of the implant comprise a single lead or multi-lead thread-form having a three-dimensional (3D) stabilization thread configuration comprising a feature set comprised of curved surfaces, linear surfaces, or any combination thereof, for example, such that a crest or distal portion of the thread comprises an increased or greater size or dimension, relative to a horizontal plane that is perpendicular to the longitudinal axis of the dental implant and passes through the crest portion of the thread, when compared to a proximal portion of the thread (e.g., generally near the root of the thread) which comprises a decreased or lesser size or dimension relative to that of the crest portion of the thread. In example embodiments, the feature set can optionally be formed along a superior flank portion and/or an inferior flank portion of the thread-form, optionally in addition to one or more feature sets being formed along the root or crest portions. Thus, in example embodiments, the one or more threads 1130 comprise a feature set comprised of curved surfaces, linear surfaces, or any combination thereof, formed along at least a portion of the root portion, crest portion, superior flank portion, inferior flank portion, or any combination thereof. In further example embodiments, the threads 1130 comprise a three-dimensional (3D) stabilization thread configuration along all or at least a portion of the implant body, optionally in combination with any standard thread configuration (e.g., v-threads, buttress threads, etc.) along another portion of the implant body. In some particular example embodiments, the implant 1100 may have a longitudinal axis extending between a first end 1114 and a second end 1116, the implant further comprising a lateral wall region 1170 proximal the first end and an apical wall region 1172 proximal the second end. In example embodiments, the apical wall region 1172 is tapered from a larger outer diameter to a smaller outer diameter toward the second end 1116, and the lateral wall region 1170 has a generally constant (non-tapered) outer diameter. In some example embodiments, an external thread form 1130 extends along the outer periphery of the implant body in both the lateral and apical wall regions, with the external thread form comprising a generally constant external diameter defined along at least a portion of the lateral wall region, and a generally tapering external diameter along at least a portion of the apical wall region. In particular example embodiments, the external thread form comprises a first thread profile along at least a portion of the lateral wall region and a second thread profile along at least a portion of the apical wall region. In some example embodiments, the taper of the implant body is between about 4° to about 8°, and in particular embodiments about 6° to 7°, for example about 6.25°, relative to the longitudinal axis Y of the implant body. In particular example embodiments, the first thread profile comprises a root, a crest portion, a superior flank portion, and an inferior flank portion, the root defined at a proximal portion of the external thread form, the crest portion defined near a distal portion of the thread form, the superior flank portion positioned on a superior portion of the thread between the crest portion and the root of the thread form, and the inferior flank portion positioned on an inferior portion of the thread between the crest portion and the root of the thread form. In particular example embodiments, the first thread profile comprises a three-dimensional stabilization thread having an undercut along the inferior flank portion, the superior flank portion or a combination of both the inferior flank portion and the superior flank portion, the undercut defined by at least one surface selected from the group consisting of a curved surface, a linear surface, or combinations thereof, between the root and crest portion of the thread form, whereby a distal portion of the three-dimensional stabilization thread has a greater dimension in a direction parallel to the longitudinal axis than a proximal portion of the three-dimensional stabilization thread. In some example embodiments, the three-dimensional thread profile has a trapezoidal thread geometry, for example with side faces of the thread body oriented at about 10° to about 15° relative to the radial dimension (i.e., transverse or perpendicular to the longitudinal axis) of the implant body. In some example embodiments, the second thread profile comprises a standard thread profile such as, for example, a V-thread, U-thread, Acme, trapezoidal, buttress, or other thread profile. In further example embodiments, other implant geometries and/or thread-forms may be provided, for example as described in greater detail with respect to the previous embodiments. In various example embodiments, the channel, groove or flute of the second helix 1180 may extend across or through all or a portion of the threads 1130, for example across or through all or at least a portion of the three-dimensional stabilization thread segment, to form one or more cutting edges or cutting elements 1181 along all or at least a portion of the length of the implant 1100, for example at least along the tapered apical wall region 1172.

Experiments were performed comparing the insertion of an implant having a second helix with an equal diameter implant using classic cutting flukes or cutting flutes. In the test protocol, high density polyurethane was used to simulate bone. A block of polyurethane was secured to a workstation and 3.2 mm holes were drilled in the block. The implants were then inserted using a digital torque wrench (Tohnichi, Japan). The insertion torque was recorded in Newton centimeters after each complete turn and the data recorded. These data are shown in Tables 1 and 2 below.

TABLE 1
Insertion Torque for Implant with
Second Helix, 0.125″ (3.2 mm) hole

| # of | Sam- | Sam- | Sam- | Sam- | Sam- | |
|---|---|---|---|---|---|---|
| turns | ple 1 | ple 2 | ple 3 | ple 4 | ple 5 | Average |
| 1 | | 6 | 6 | 6 | 6 | 6 |
| 2 | | 10 | 10 | 9 | 6 | 8.75 |
| 3 | | 12 | 12 | 12 | 9 | 11.25 |
| 4 | | 13 | 14 | 15 | 10 | 13 |
| 5 | | 15 | 16 | 17 | 12 | 15 |
| 6 | | 16 | 18 | 19 | 14 | 16.75 |
| 7 | | 17 | 19 | 22 | 16 | 18.5 |
| 8 | | 20 | 21 | 23 | 19 | 20.75 |
| 9 | | 22 | 23 | 23 | 20 | 22 |
| 10 | | 26 | 26 | 26 | 22 | 25 |
| 11 | | 27 | 28 | 29 | 23 | 26.75 |
| 12 | | 31 | 28 | 31 | 29 | 29.75 |
| 13 | | 42 | 45 | 47 | 45 | 44.75 |

TABLE 2
Insertion torque for Classic Cutting Flutes 0.125″ (3.2 mm) hole

| # of turns | Test 1 | Test 2 | Test 3 | Test 4 | Average |
|---|---|---|---|---|---|
| 1 | 4 | 6 | 5 | 7 | 5.5 |
| 2 | 8 | 10 | 9 | 9 | 9 |
| 3 | 10 | 11 | 11 | 10 | 10.5 |
| 4 | 12 | 13 | 14 | 13 | 13 |
| 5 | 16 | 18 | 15 | 16 | 16.25 |
| 6 | 18 | 19 | 19 | 19 | 18.75 |
| 7 | 22 | 22 | 24 | 23 | 22.75 |
| 8 | 25 | 27 | 29 | 27 | 27 |
| 9 | 32 | 33 | 35 | 32 | 33 |
| 10 | 37 | 41 | 42 | 38 | 39.5 |
| 11 | 44 | 49 | 51 | 47 | 47.75 |
| 12 | 54 | 62 | 65 | 59 | 60 |
| 13 | 67 | 78 | 80 | 77 | 75.5 |

The data in Tables 1 and 2 show that the insertion torque of the implant with a second helix is comparable to the insertion torque of the implant with a classic design for shallower insertion depths. However, as depth of insertion increases, the classic implant design requires significantly more torque to insert in contrast to the implant with the second helix. The implants with the second helix only required an average of 20.75 N cm of torque during insertion of turn 8 compared with 27 N cm of torque for the version of the implant having classic cutting flutes. The results are even more dramatic at 13 turns in which the implant with a second helix only required 44.75 N cm of torque compared to 75.5 N cm of torque for the version of the implant having classic cutting flutes. Without being limited by theory, it is expected that provision of the second helix will allow easier insertion by a surgeon and reduce the discomfort felt by the patient. Limiting insertion torque also reduces the likelihood of bony facture due to excessive force during insertion. This current technology is able to achieve reduced insertion torque without sacrificing initial stability.

A second set of experiments were performed to further test insertion torque. Table 3 below shows the insertion torque for an implant with a second helix.

TABLE 3
Insertion Torque for Impant with Second Helix

| | Implant Number/Torque N cm | | | | | | | | | | | | Mean | Std. |
|---|---|---|---|---|---|---|---|---|---|---|---|---|---|---|
| Turns | 1 | 2 | 3 | 4 | 5 | 6 | 7 | 8 | 9 | 10 | 11 | 12 | Torq. | Dev. |
| 1 | 1 | 1.8 | 2.4 | 1 | 2.6 | 1 | 1 | 1.4 | 1.4 | 3.6 | 2.4 | 5.6 | 2.1 | 1.376 |
| 2 | 3.2 | 2 | 3.8 | 1.2 | 10.2 | 1.4 | 1.2 | 8 | 6 | 3.8 | 2.4 | 13.2 | 4.7 | 3.895 |
| 3 | 3.8 | 2.6 | 17.4 | 1.6 | 17.4 | 5.2 | 1.6 | 16.8 | 15.6 | 4.4 | 12.4 | 22.4 | 8.37 | 7.599 |
| 4 | 4.4 | 3.7 | 42.2 | 5.2 | 31.6 | 8.4 | 6.6 | 27.2 | 23.8 | 9.4 | 21 | 28.2 | 17.6 | 12.97 |
| 5 | 5.8 | 5.6 | 48 | 6.4 | 35.4 | 11.6 | 13.4 | 39.6 | 37 | 19.4 | 36.4 | 44.4 | 25.25 | 16.34 |
| 6 | 6.8 | 15.8 | 64.8 | 7.2 | 41 | 18.2 | 20.4 | 55.4 | 49.4 | 25.2 | 47.8 | 56 | 34 | 20.6 |
| 7 | 13.4 | 22.8 | 82.6 | 8 | 54.8 | 24.4 | 26.6 | 59.2 | 49.4 | 40 | 49.2 | 72 | 41.9 | 23.37 |
| 8 | 20.4 | 37.8 | 83.8 | 9.2 | 70.4 | 42.8 | 29.4 | 60 | 62.6 | 54 | 54.4 | 88 | 51.1 | 24.21 |
| 9 | 29.2 | 49.2 | 91.8 | 11.1 | 92.6 | 58.2 | 47.4 | 74.8 | 80.2 | 67.2 | 66.4 | 101.2 | 61.1 | 26.81 |
| 10 | 35 | 63.8 | 113.2 | 12.6 | 101.2 | 64.6 | 58.4 | 94.2 | 98.2 | 79.8 | 84.8 | 126.2 | 77.67 | 32.63 |
| 11 | 43.8 | 78.4 | | 13.2 | 123.4 | 67.2 | 76.6 | 121.2 | 130.8 | 96.2 | 97.8 | | 84.9 | |
| 12 | 59.2 | 90 | | 15.8 | | 84.2 | 76.6 | | | 122.6 | 136.2 | | 83.5 | |
| Height | 3.71 | 3.77 | 3.71. | 3.74 | 3.79 | 3.7 | 3.72 | 3.7 | 3.71 | 3.91 | 3.81 | 3.84 | | |
| (mm) | | | | | | | | | | | | | | |

Table 4 below shows the insertion torque for a fluted implant.

TABLE 4
Insertion Torque for Fluted Implants

| | Implant Number/Torque N cm | | | | | | | | | | | | Mean | Std. |
|---|---|---|---|---|---|---|---|---|---|---|---|---|---|---|
| Turns | 1 | 2 | 3 | 4 | 5 | 6 | 7 | 8 | 9 | 10 | 11 | 12 | Torq. | Dev. |
| 1 | 10.8 | 9.2 | 7.6 | 8.6 | 9.2 | 8.4 | 9.2 | 9.4 | 7.4 | 6.2 | 6.6 | 7.2 | 8.317 | 1.34 |
| 2 | 13.6 | 18.8 | 13.6 | 15.2 | 14.8 | 19.2 | 18.6 | 16.8 | 15.8 | 12.8 | 18.2 | 17.6 | 16.25 | 2.26 |
| 3 | 22 | 27.6 | 18.2 | 18.6 | 26.8 | 27.8 | 30.6 | 28.6 | 24 | 23.2 | 28.8 | 24.4 | 25.05 | 4.02 |
| 4 | 28.2 | 45 | 26.6 | 26.6 | 29.4 | 40.4 | 45.6 | 42.4 | 34.8 | 38.6 | 41 | 40 | 36.55 | 7.14 |
| 5 | 41.8 | 58.4 | 43.4 | 40.2 | 44.4 | 54.6 | 54.2 | 58 | 45 | 49.8 | 47.4 | 54.2 | 49.28 | 6.43 |
| 6 | 59 | 71.4 | 57.2 | 50.6 | 60.2 | 70.8 | 73.2 | 74.6 | 60.2 | 61 | 59.4 | 69.8 | 63.95 | 7.64 |
| 7 | 85.2 | 78.2 | 78.4 | 70.4 | 84.2 | 94.2 | 93.8 | 92.2 | 81.8 | 81 | 80.2 | 93.8 | 84.45 | 7.63 |
| 8 | 106.4 | 94.2 | 105.4 | 98.8 | 106.8 | 131.8 | 134.2 | 121.2 | 108.6 | 107.2 | 101 | 140.8 | 113 | 15.18 |
| 9 | 132.8 | 120.8 | 129 | 123.8 | 135 | 170.2 | 168.2 | 151.2 | 124.6 | 139.6 | 125 | 152.2 | 139.4 | 17.24 |
| 10 | 159.2 | 145.6 | 158.4 | 156 | 185.2 | 202.4 | 200.4 | 185.2 | 160.2 | 161.2 | 167.4 | 184 | 172.1 | 18.59 |
| Height | 3.62 | 3.56 | 3.6 | 3.71 | 3.72 | 3.72 | 3.66 | 3.6 | 3.66 | 3.86 | 3.83 | 3.88 | | |
| (mm) | | | | | | | | | | | | | | |

Table 5 below shows the insertion torque for a non-fluted implant.

TABLE 5
Insertion Torque for Non-Fluted Implant

| | Implant Number/Torque N cm | | | | | | | | | | | | Mean | Std. |
|---|---|---|---|---|---|---|---|---|---|---|---|---|---|---|
| Turns | 1 | 2 | 3 | 4 | 5 | 6 | 7 | 8 | 9 | 10 | 11 | 12 | Torq. | Dev. |
| 1 | 18.8 | 4.8 | 13.4 | 8.8 | 9.4 | 11.2 | 8.4 | 10.4 | 3.6 | 6.4 | 15.2 | 5.6 | 9.67 | 4.48 |
| 2 | 44.8 | 39.4 | 39 | 39.6 | 24.4 | 39 | 37.4 | 41.2 | 21.8 | 36.2 | 43.8 | 23.8 | 35.87 | 7.95 |
| 3 | 74.6 | 71.8 | 70.2 | 71.4 | 49.2 | 69.8 | 68.6 | 69.8 | 41.6 | 67.6 | 71 | 46.2 | 64.32 | 11.49 |
| 4 | 103.6 | 96.4 | 98.2 | 99.2 | 72.2 | 96.6 | 99 | 98.8 | 59 | 99.4 | 97.2 | 68.2 | 90.65 | 14.98 |
| 5 | 133 | 121.4 | 124 | 131.4 | 101.2 | 126.4 | 125 | 130.4 | 78.6 | 128.4 | 123.2 | 89.2 | 117.7 | 17.90 |
| 6 | 159.6 | 142 | 155.4 | 152.6 | 123.2 | 158.8 | 143.8 | 162.4 | 94.4 | 162.2 | 150.6 | 106.6 | 142.6 | 22.67 |
| 7 | 182.8 | 159.8 | 177.2 | 186.4 | 139.2 | 176.6 | 173.4 | 190.6 | 114.8 | 200.2 | 176.8 | 125.6 | 167 | 26.77 |
| 8 | 198 | 199 | 199.8 | 207.6 | 151.4 | 203 | 198.4 | 200.2 | 126.6 | 213.6 | 204 | 141.8 | 187 | 29.18 |
| 9 | 213.8 | 208.6 | 222.8 | 209.8 | 166.6 | 221.8 | 212 | 221.6 | 157.8 | 232.6 | 218.6 | 176.8 | 205.2 | 24.27 |
| Height | 4.41 | 4.47 | 4.41 | 4.42 | 4.34 | 4.44 | 4.43 | 4.48 | 4.42 | 4.48 | 4.49 | 4.5 | | |
| (mm) | | | | | | | | | | | | | | |

As can be readily seen, the implants with a second helix require substantially less torque for insertion. Without being limited by theory, it is expected that this may result in less discomfort to the patient, less effort for the dentist, protective of the patient's bone, and as shown below a more stable implant.

Traditional dental implants typically may require from 3-6 months to stabilize following implantation before a prosthesis can be installed. This is because the implants are subject to small amounts of motion called micromotion, movement between the bone and the implant, in the range of a few microns to almost a millimeter in bad cases. This is believed to be caused by a number of factors. In many cases, when a hole is drilled, the bore may not be uniformly round and may have voids or protruding portions surround the hole. When an implant is inserted into the bore, it typically will follow the path of least resistance and will be pushed aside in regions where there is a protrusion in the wall and will follow areas where there is a void in the wall. Conventional implants press upon the walls of the bore more than they cut a thread. The coarse nature of cutting grooves on conventional implants require sufficiently high torque such that they will be pushed aside rather than cut a thread as it follows the path of least resistance. If the implant is not true in the bore, it will have greater motion until bone grows around it and before it can be safely loaded by chewing. Typically, this waiting period is 3-6 months.

Additionally, the areas of bone that are subject to pressure from the implant will initially experience absorption of the bone before new bone is deposited. This results in a loosening of the initial fit of the implant.

Implantation of conventional self-tapping implants is usually spread over 3-6 months. On the initial visit, the bore for the implant will be drilled and the implants placed. The patient must then wait until new bone growth stabilizes the implants at which point the patient returns for installation of any prosthesis.

Implants having a second helix may substantially eliminate micromotion and therefore allow immediate loading of the implant. Without being limited to any theory, the reduction of micromotion is believed to result from a combination of factors. First, the sharp cutting surfaces are believed to overcome the forces exerted by protrusions in the bore allowing the implant to be inserted true to the bore. Second, because implants having a second helix cut better grooves, there are fewer regions of high pressure and therefore less bone absorption following implantation.

Experiments were performed to determine the micromotion of several implants by applied force. A total of 36 titanium implants representing three categories: an implant having a second helix, a fluted conventional implant, and a non-fluted conventional implant, were loaded onto six, 5 cm×5 cm solid, rigid polyurethane foam blocks (Sawbones, Wash., USA) simulating bone with a hardness of D2. Each implant was fitted with a one-piece abutment to allow for the application of a load. Identical abutments were used throughout the procedure. A groove has been machined on each abutment, in order to make sure that the point of application of the force to the crest of the bone is always the same. A customized loading device, consisting of a digital micrometer (Mitutoyo Absolute Digimatic) and digital force gauge (Chantillion E-DFE-025) was used to determine implant micromotion.

The implants were placed in the polyurethane foam blocks utilizing the Tohnichi Digital Torque Gauge. The implants were loaded into the polyurethane block up to the base of the micro-thread. Torque was recorded after each turn of the implant into the blocks. The abutment was then placed on the implant and secured using an insertion torque of 35 N cm as measured by a TOHNICHI Digital Torque Gauge Model BTGE IOCN.

After the implants were placed, the polyurethane blocks were fixed on a customized loading apparatus for the evaluation of micromovement. The apparatus consisted of a digital force gauge (Chantillion E-DFE-025) vertically fixed onto a frame and, on the opposite side, a digital micrometer (Mitutoyo Absolute Digimatic) that measured the micromotion of the abutment during the load application. The forces were achieved by turning a dial that controlled the height of the force gauge. This dialed-in force was applied to the abutment via a lever. The micrometer was placed tangent to the crown of the abutment to detect displacement. Loads were tested on each implant starting at 10 N cm and continuing to 100 N cm and measured at 5 N cm increments.

Table 6 below shows the micromovement of an implant having a second helix.

TABLE 6
Micromovement of Implant of Having a Second Helix

| | | | | | | | | | | | | | Mean | |
|---|---|---|---|---|---|---|---|---|---|---|---|---|---|---|
| | Implant Number/Motion | | | | | | | | | | | | Disp. t | |
| Force | 1 | 2 | 3 | 4 | 5 | 6 | 7 | 8 | 9 | 10 | 11 | 12 | (mm) | Dev |
| 10 | 0.027 | 0.031 | 0.029 | 0.015 | 0.024 | 0.033 | 0.027 | 0.03 | 0.025 | 0.034 | 0.032 | 0.03 | 0.03 | 0.01 |
| 15 | 0.053 | 0.05 | 0.043 | 0.031 | 0.038 | 0.059 | 0.048 | 0.063 | 0.049 | 0.059 | 0.05 | 0.043 | 0.05 | 0.01 |
| 20 | 0.07 | 0.068 | 0.058 | 0.051 | 0.057 | 0.084 | 0.068 | 0.102 | 0.088 | 0.1 | 0.066 | 0.059 | 0.07 | 0.02 |
| 25 | 0.095 | 0.091 | 0.081 | 0.066 | 0.076 | 0.114 | 0.096 | 0.115 | 0.112 | 0.135 | 0.088 | 0.082 | 0.10 | 0.02 |
| 30 | 0.116 | 0.113 | 0.102 | 0.089 | 0.098 | 0.136 | 0.121 | 0.136 | 0.133 | 0.162 | 0.106 | 0.107 | 0.12 | 0.02 |
| 35 | 0.14 | 0.133 | 0.125 | 0.108 | 0.124 | 0.166 | 0.15 | 0.155 | 0.153 | 0.19 | 0.133 | 0.126 | 0.14 | 0.02 |
| 40 | 0.164 | 0.156 | 0.15 | 0.129 | 0.148 | 0.193 | 0.175 | 0.179 | 0.172 | 0.21 | 0.158 | 0.149 | 0.17 | 0.02 |
| 45 | 0.187 | 0.184 | 0.173 | 0.15 | 0.173 | 0.223 | 0.206 | 0.201 | 0.193 | 0.236 | 0.187 | 0.171 | 0.19 | 0.02 |
| 50 | 0.214 | 0.207 | 0.2 | 0.175 | 0.201 | 0.252 | 0.237 | 0.226 | 0.217 | 0.265 | 0.218 | 0.197 | 0.22 | 0.02 |
| 55 | 0.238 | 0.234 | 0.224 | 0.202 | 0.23 | 0.284 | 0.28 | 0.257 | 0.237 | 0.287 | 0.249 | 0.22 | 0.25 | 0.03 |
| 60 | 0.263 | 0.264 | 0.251 | 0.231 | 0.259 | 0.316 | 0.305 | 0.279 | 0.26 | 0.315 | 0.283 | 0.238 | 0.27 | 0.03 |
| 65 | 0.291 | 0.291 | 0.279 | 0.259 | 0.294 | 0.351 | 0.34 | 0.308 | 0.285 | 0.346 | 0.323 | 0.27 | 0.30 | 0.03 |
| 70 | 0.324 | 0.32 | 0.307 | 0.287 | 0.324 | 0.386 | 0.374 | 0.339 | 0.309 | 0.378 | 0.364 | 0.297 | 0.33 | 0.03 |
| 75 | 0.346 | 0.348 | 0.335 | 0.315 | 0.358 | 0.42 | 0.409 | 0.377 | 0.335 | 0.412 | 0.4 | 0.324 | 0.36 | 0.04 |
| 80 | 0.376 | 0.376 | 0.364 | 0.343 | 0.39 | 0.454 | 0.449 | 0.39 | 0.361 | 0.448 | 0.438 | 0.355 | 0.40 | 0.04 |
| 85 | 0.408 | 0.411 | 0.39 | 0.375 | 0.426 | 0.492 | 0.486 | 0.42 | 0.385 | 0.478 | 0.483 | 0.383 | 0.43 | 0.04 |
| 90 | 0.437 | 0.439 | 0.42 | 0.405 | 0.459 | 0.532 | 0.523 | 0.447 | 0.413 | 0.516 | 0.518 | 0.412 | 0.46 | 0.049 |
| 95 | 0.468 | 0.472 | 0.452 | 0.445 | 0.498 | 0.597 | 0.561 | 0.48 | 0.44 | 0.552 | 0.575 | 0.443 | 0.46 | 0.057 |
| 100 | 0.5 | 0.505 | 0.477 | 0.477 | 0.53 | 0.616 | 0.598 | 0.511 | 0.469 | 0.587 | 0.615 | 0.475 | 0.53 | 0.058 |

Table 7 below shows the micromovement of a conventional fluted implant. The mean displacement is higher than in the implants having a second helix.

TABLE 7
Micromovement of Conventional Fluted Implant

| | | | | | | | | | | | | | Mean | |
|---|---|---|---|---|---|---|---|---|---|---|---|---|---|---|
| | Implant Number/Motion | | | | | | | | | | | | Disp. t | Std. |
| Force | 1 | 2 | 3 | 4 | 5 | 6 | 7 | 8 | 9 | 10 | 11 | 12 | (mm) | Dev |
| 10 | 0.025 | 0.029 | 0.02 | 0.026 | 0.023 | 0.029 | 0.02 | 0.018 | 0.019 | 0.029 | 0.036 | 0.026 | 0.03 | 0.01 |
| 15 | 0.038 | 0.045 | 0.052 | 0.041 | 0.034 | 0.103 | 0.072 | 0.048 | 0.045 | 0.044 | 0.09 | 0.05 | 0.06 | 0.02 |
| 20 | 0.053 | 0.065 | 0.111 | 0.056 | 0.048 | 0.174 | 0.13 | 0.113 | 0.081 | 0.061 | 0.148 | 0.082 | 0.09 | 0.04 |
| 25 | 0.072 | 0.097 | 0.142 | 0.077 | 0.088 | 0.242 | 0.207 | 0.197 | 0.128 | 0.121 | 0.181 | 0.139 | 0.14 | 0.06 |
| 30 | 0.09 | 0.17 | 0.164 | 0.123 | 0.131 | 0.277 | 0.274 | 0.24 | 0.203 | 0.206 | 0.215 | 0.179 | 0.19 | 0.06 |
| 35 | 0.11 | 0.26 | 0.188 | 0.188 | 0.177 | 0.318 | 0.306 | 0.27 | 0.24 | 0.234 | 0.249 | 0.204 | 0.23 | 0.06 |
| 40 | 0.131 | 0.339 | 0.207 | 0.238 | 0.219 | 0.345 | 0.319 | 0.291 | 0.262 | 0.26 | 0.281 | 0.227 | 0.26 | 0.06 |
| 45 | 0.15 | 0.37 | 0.227 | 0.266 | 0.239 | 0.372 | 0.338 | 0.312 | 0.286 | 0.287 | 0.315 | 0.253 | 0.28 | 0.06 |
| 50 | 0.172 | 0.395 | 0.248 | 0.293 | 0.26 | 0.403 | 0.356 | 0.331 | 0.312 | 0.313 | 0.351 | 0.276 | 0.31 | 0.07 |
| 55 | 0.194 | 0.422 | 0.269 | 0.347 | 0.283 | 0.441 | 0.38 | 0.351 | 0.341 | 0.34 | 0.371 | 0.308 | 0.34 | 0.07 |
| 60 | 0.216 | 0.452 | 0.294 | 0.362 | 0.303 | 0.463 | 0.401 | 0.372 | 0.367 | 0.37 | 0.402 | 0.33 | 0.36 | 0.07 |
| 65 | 0.241 | 0.473 | 0.316 | 0.379 | 0.324 | 0.492 | 0.425 | 0.39 | 0.386 | 0.399 | 0.443 | 0.354 | 0.39 | 0.07 |
| 70 | 0.264 | 0.5 | 0.34 | 0.406 | 0.353 | 0.525 | 0.448 | 0.412 | 0.415 | 0.425 | 0.465 | 0.38 | 0.41 | 0.07 |
| 75 | 0.288 | 0.534 | 0.365 | 0.435 | 0.374 | 0.554 | 0.474 | 0.44 | 0.446 | 0.453 | 0.495 | 0.402 | 0.44 | 0.07 |
| 80 | 0.312 | 0.559 | 0.391 | 0.468 | 0.395 | 0.585 | 0.498 | 0.47 | 0.473 | 0.482 | 0.528 | 0.429 | 0.47 | 0.08 |
| 85 | 0.337 | 0.601 | 0.418 | 0.498 | 0.421 | 0.618 | 0.524 | 0.501 | 0.5 | 0.51 | 0.567 | 0.456 | 0.50 | 0.08 |
| 90 | 0.382 | 0.628 | 0.447 | 0.525 | 0.441 | 0.648 | 0.551 | 0.528 | 0.526 | 0.539 | 0.594 | 0.484 | 0.52 | 0.08 |
| 95 | 0.408 | 0.66 | 0.48 | 0.563 | 0.466 | 0.679 | 0.574 | 0.561 | 0.559 | 0.571 | 0.627 | 0.513 | 0.56 | 0.08 |
| 100 | 0.427 | 0.694 | 0.511 | 0.599 | 0.494 | 0.705 | 0.6 | 0.592 | 0.588 | 0.602 | 0.672 | 0.547 | 0.59 | 0.08 |

Table 8 below shows the micromovement of a conventional non-fluted implant. The mean displacement is higher still than either the implants having a second helix or the conventional fluted implant.

TABLE 8
Micromovement of Conventional Non-Fluted Implant

| | | | | | | | | | | | | | Mean | |
|---|---|---|---|---|---|---|---|---|---|---|---|---|---|---|
| | Implant Number/Motion | | | | | | | | | | | | Disp. t | |
| Force | 1 | 2 | 3 | 4 | 5 | 6 | 7 | 8 | 9 | 10 | 11 | 12 | (mm) | Dev |
| 10 | 0.032 | 0.032 | 0.023 | 0.056 | 0.026 | 0.104 | 0.028 | 0.067 | 0.011 | 0.014 | 0.091 | 0.028 | 0.04 | 0.03 |
| 15 | 0.059 | 0.067 | 0.048 | 0.074 | 0.045 | 0.198 | 0.077 | 0.116 | 0.027 | 0.049 | 0.177 | 0.054 | 0.08 | 0.05 |
| 20 | 0.094 | 0.114 | 0.077 | 0.116 | 0.08 | 0.31 | 0.145 | 0.171 | 0.088 | 0.102 | 0.255 | 0.096 | 0.14 | 0.07 |
| 25 | 0.132 | 0.185 | 0.099 | 0.175 | 0.12 | 0.433 | 0.188 | 0.242 | 0.125 | 0.168 | 0.343 | 0.132 | 0.20 | 0.10 |
| 30 | 0.163 | 0.231 | 0.123 | 0.226 | 0.168 | 0.534 | 0.218 | 0.32 | 0.183 | 0.229 | 0.432 | 0.18 | 0.25 | 0.12 |
| 35 | 0.221 | 0.259 | 0.143 | 0.258 | 0.235 | 0.649 | 0.248 | 0.403 | 0.244 | 0.331 | 0.538 | 0.228 | 0.31 | 0.15 |
| 40 | 0.258 | 0.284 | 0.164 | 0.289 | 0.283 | 0.74 | 0.28 | 0.456 | 0.297 | 0.428 | 0.62 | 0.264 | 0.36 | 0.17 |
| 45 | 0.292 | 0.31 | 0.185 | 0.317 | 0.307 | 0.796 | 0.304 | 0.501 | 0.329 | 0.505 | 0.703 | 0.287 | 0.40 | 0.19 |
| 50 | 0.322 | 0.335 | 0.207 | 0.343 | 0.331 | 0.862 | 0.331 | 0.541 | 0.35 | 0.573 | 0.798 | 0.317 | 0.44 | 0.21 |
| 55 | 0.351 | 0.358 | 0.227 | 0.373 | 0.356 | 0.915 | 0.358 | 0.579 | 0.375 | 0.615 | 0.86 | 0.346 | 0.48 | 0.22 |
| 60 | 0.379 | 0.383 | 0.248 | 0.399 | 0.381 | 0.945 | 0.388 | 0.615 | 0.4 | 0.65 | 0.896 | 0.373 | 0.50 | 0.22 |
| 65 | 0.405 | 0.407 | 0.273 | 0.427 | 0.404 | 0.98 | 0.417 | 0.649 | 0.425 | 0.707 | 0.933 | 0.403 | 0.54 | 0.23 |
| 70 | 0.432 | 0.434 | 0.293 | 0.456 | 0.432 | 1.019 | 0.445 | 0.684 | 0.45 | 0.764 | 0.966 | 0.431 | 0.57 | 0.23 |
| 75 | 0.465 | 0.46 | 0.318 | 0.489 | 0.457 | 1.054 | 0.474 | 0.723 | 0.479 | 0.804 | 0.995 | 0.461 | 0.60 | 0.24 |
| 80 | 0.491 | 0.49 | 0.336 | 0.52 | 0.485 | 1.091 | 0.509 | 0.763 | 0.505 | 0.845 | 1.03 | 0.496 | 0.63 | 0.24 |
| 85 | 0.524 | 0.521 | 0.36 | 0.535 | 0.513 | 1.143 | 0.545 | 0.8 | 0.542 | 0.888 | 1.08 | 0.569 | 0.67 | 0.25 |
| 90 | 0.558 | 0.553 | 0.385 | 0.552 | 0.545 | 1.191 | 0.583 | 0.839 | 0.57 | 0.959 | 1.113 | 0.569 | 0.70 | 0.26 |
| 95 | 0.588 | 0.59 | 0.41 | 0.605 | 0.58 | 1.238 | 0.631 | 0.881 | 0.596 | 1.024 | 1.163 | 0.607 | 0.74 | 0.27 |
| 100 | 0.632 | 0.623 | 0.435 | 0.642 | 0.616 | 1 | 0.67 | 0.924 | 0.639 | 1.074 | 1.197 | 0.649 | 0.78 | 0.27 |

From the above, the reduction of micromotion in the implants with a second helix is readily apparent.

Example embodiments of the implant having a combination of the three-dimensional thread form and reverse helix cutting flutes as disclosed herein have been found to provide reduced insertion torque and/or improved implant stability when compared to previously known implants. Insertion torque measurement tests as referenced herein were performed using example implants having both a three-dimensional thread form and reverse helix cutting flutes, and the peak or maximum insertion torque required for placement of each implant into the implant site or osteotomy was measured. Example implants were inserted into osteotomies within foam blocks made from SAWBONES 40 pcf test medium material, which is an alternative test medium for dense bone. The osteotomies were prepared using a drill sequence with increasing drill diameters and alternating bits. First a 0.0787 inch (2.0 mm) drill was used to initiate the osteotomy in the foam block. Then a 0.0984 inch (2.5 mm) drill was used to increase the depth and width of the osteotomy. A 0.126 inch (3.2 mm) drill and a 0.146 inch (3.7 mm) drill were also used in sequence to incrementally widen the osteotomy. An implant driver was then used to drive the implants into the osteotomy. The example implants used had an outer diameter of about 0.166 inches (4.2 mm) and lengths of about 0.240 inches (15 mm). The maximum torque exerted on the block during insertion of each implant into the osteotomy was measured using a torque indicator/sensor.

Example embodiments of the implant showed reduced insertion torque compared to previously known implants. In example embodiments, the maximum or peak insertion torque required for implant placement at a placement site or osteotomy in human or animal bone tissue or a bone test medium material such as SAWBONES 40 pcf test medium material having substantially equivalent characteristics to human bone tissue (a “bone medium”) is less than about 93 N cm, and in particular examples less than about 90 N cm, less than about 85 N cm, less than about 82 N cm, and in some example embodiments less than about 80 N cm, or less than about 75-79N cm.

The stability upon placement in a bone medium of example embodiments of the implants having a combination of the three-dimensional thread form and the reverse helix cutting flutes as disclosed herein was measured using lateral force resistance evaluation. Osteotomies were prepared on the seam between two abutting foam blocks made from SAWBONES 40 pcf test medium material, in the manner previously described. Implants comprising both three-dimensional thread forms and reverse helix cutting flutes and having an outer diameter of about 0.166 inches (4.2 mm) and lengths of about 0.240 inches (15 mm) were inserted into the osteotomies. Half of the block/implant combination was then fixtured to a dynamic loading machine, and the other half was pulled away from the first half. The dynamic loading machine measured the resistance to lateral force of the example implants by measuring the maximum force perpendicular to the implant axis required to separate the block from the implant. Example embodiments of the implant upon placement in a bone medium maintained a resistance to lateral force of up to about 13.5 lbf, and stability or resistance to micromotion as indicated in the data above.

According to another example aspect and embodiments, the present invention further comprises methods of manufacturing an implant comprising at least one three-dimensional stabilization thread form extending along a first or forward helical direction or path, and at least one second helix channel or flute extending along a second, generally opposite, or reverse helical direction or path. In example embodiments, the method includes providing an implant blank such as for example an at least partially tapered implant body blank; machining or otherwise forming one or more threads along at least a portion of the implant body, the one or more threads preferably at least partially comprising a three-dimensional stabilization thread form and optionally one or more additional thread forms as described in greater detail above, and extending along a first (e.g., right-hand or forward) helical direction or path; machining or otherwise forming one or more second helix channels, grooves or flutes along at least a portion of the implant body along a second (e.g., left-hand or reverse) helical direction or path generally opposite and across and through the one or more threads such that at least one cutting edge is created between the intersection of the second helix and the inferior flank of the threads. In alternate embodiments, the one or more second helix channels, grooves or flutes may be machined or otherwise formed in the blank in the second helical direction first, and the one or more external three-dimensional stabilization threads subsequently machined or otherwise formed in the first helical direction to create the one or more cutting edges. Alternatively, the threads and the second helix channels, grooves or flutes may be formed simultaneously, for example by casting, molding or other fabrication processes. The method optionally further comprises treating the body and one or more threads with a particle blast process. According to example embodiments, the particle blast process preferably roughens or texturizes the outer surface of the implant such that the osseointegration of the dental implant to the surrounding bone is improved. According to example embodiments, an outer surface of the implant body comprises a roughened surface (in Sa) of between about 0.5-4.0 μm. In alternate example embodiments, the roughened surface can preferably be chosen as desired, for example, less 0.5 μm than or greater than 4.0 μm. According to example embodiments, any edges defined along one or more portions of the body (and one or more threads thereof) are substantially rounded.

As similarly described above, the one or more threads 30, 130, 230, 330, 430, 530, 630, 730, 830, 930, 1030, 1130 of the implants 10, 100, 200, 300, 400, 500, 600, 700, 800, 900, 1000, 1100 can comprise a feature set on one or more leads, comprised of curved surfaces, linear surfaces, or any combination thereof, formed along at least a portion of the root portion, crest portion, superior flank portion, inferior flank portion, or any combination across any and all thread leads thereof. In example embodiments and as similarly described above, the implants 10, 100, 200, 300, 400, 500, 600, 700, 800, 900, 1000, 1100 can comprise one or more self-tapping cutting flutes extending along the body and forming interruptions with the one or more threads, and/or one or more second helixes traversing the body of the implant in a direction opposite the one or more threads that creates a cutting edge on the threads. Optionally, according to other example embodiments of the present invention, the implants 10, 100, 200, 300, 400, 500, 600, 700, 800, 900, 1000, 1100 can comprise a desirable length, and other dimensional attributes of the implant, thread forms, unique feature sets, cutting flutes, etc. can be chosen as desired. Preferably, the one or more threads, thread forms, unique feature sets, etc. as described herein can be sized and shaped as desired, for example, to provide for maximizing the restriction of lateral movement of the implant within the full or partial osteotomy. According to some example embodiments, the implants 10, 100, 200, 300, 400, 500, 600, 700, 800, 900, 1000, 1100 comprise a tapered body comprising multiple thread forms, for example, a three-dimensional stabilization thread form and a standard thread (e.g., v-thread, buttress thread, etc.) form on single or multi-leads.

While the invention has been described with reference to example embodiments, it will be understood by those skilled in the art that a variety of modifications, additions and deletions are within the scope of the invention, as defined by the following claims.

What is claimed is:

1. A dental implant comprising:
an implant body having distal and proximal ends, with a longitudinal axis extending lengthwise therethrough, and defining a length between the distal and proximal ends;
an external thread form extending along a generally helical path in a first helical direction around the longitudinal axis and along at least a portion of the length of the implant body between the distal and proximal ends, the external thread form at least partially comprising a three-dimensional thread profile having a root portion with a smaller thickness dimension transverse to the helical path, and a crest portion with a larger thickness dimension transverse to the helical path; and
at least one cutting flute extending along a generally helical path around the longitudinal axis in a second helical direction opposite the first helical direction and along at least a portion of the length of the implant body, wherein at least one cutting element is formed at an intersection of the at least one cutting flute with the external thread form.

2. The dental implant of claim 1, wherein the intersection of the at least one cutting flute with the external thread form defines a trailing face, a recessed face, and a clearance face.

3. The dental implant of claim 1, wherein the implant comprises a lateral portion and an apical portion having a taper different from the lateral portion.

4. The dental implant of claim 1, wherein the three-dimensional thread form comprises a generally linear surface on its crest.

5. The dental implant of claim 4, wherein the three-dimensional thread form further comprises transitional edges.

6. The dental implant of claim 1, further comprising an external surface roughened by particle blasting.

7. The dental implant of claim 6, wherein the roughened surface has an Sa surface roughness of between about 0.5-4.0 μm.

8. The dental implant of claim 1, wherein the external thread form comprises at least two different thread profiles.

9. The dental implant of claim 8, wherein one of the thread profiles comprises a standard thread profile selected from a V-thread, U-thread, Acme, trapezoidal, or buttress thread geometry.

10. The dental implant of claim 9, wherein the external thread form further comprises a transitional thread profile between the three-dimensional thread profile and the standard thread profile.

11. The dental implant of claim 9, wherein the standard thread profile extends an apical section of the implant body.

12. The dental implant of claim 11, wherein the three-dimensional thread profile extends along a lateral section of the implant body.

13. The dental implant of claim 1, wherein the three-dimensional thread profile comprises a crest relief feature.

14. The dental implant of claim 1, wherein the implant allows for placement with a peak insertion torque required for implantation that is less than or equal to about 90 N cm.

15. The dental implant of claim 14, wherein the peak insertion torque required for implantation is less than or equal to about 75-79 N cm.

16. The dental implant of claim 14, wherein the implant upon placement provides stability sufficient to resist a lateral force of at least about 13.5 lbf.

17. A dental implant comprising:
an implant body having a first end and a second end, defining a length between the first and second ends, and a longitudinal axis extending lengthwise therethrough, wherein at least a portion of the implant body is tapered from a larger diameter toward the first end to a smaller diameter toward the second end;
an external thread form extending along at least a portion of the length of the implant body and around the longitudinal axis in a first rotational direction, at least a portion of the external thread form comprising a three-dimensional stabilization thread profile having a transverse crest thickness greater than a transverse root thickness; and
at least one channel extending through the external thread form and forming at least one cutting element at an interface of the external thread form with the at least one channel, the at least one channel extending around the longitudinal axis in a second rotational direction opposite the first rotational direction.

18. The dental implant of claim 17, wherein the implant body defines a generally continuous taper from the larger diameter toward the first end to the smaller diameter toward the second end.

19. The dental implant of claim 17, wherein the implant body defines a tapered apical section and a lateral section having a generally constant outer diameter.

20. The dental implant of claim 17, wherein the external thread form comprises the three-dimensional stabilization thread profile along a first portion of the length of the implant body, and a standard thread profile along a second portion of the length of the implant body.

21. The dental implant of claim 17, wherein the three-dimensional stabilization thread profile defines a generally trapezoidal thread profile.

22. The dental implant of claim 17, wherein the implant allows for placement with a peak insertion torque required for implantation that is less than or equal to about 90 N cm.

23. The dental implant of claim 22, wherein the peak insertion torque required for implantation is less than or equal to about 75-79 N cm.

24. The dental implant of claim 22, wherein the implant upon placement provides stability sufficient to resist a lateral force of about 13.5 lbf.

25. A method of manufacturing a dental implant, the method comprising:
providing an implant body;
machining external threads along at least a portion of the implant body in a first helical direction, at least a portion of the threads comprising a three-dimensional stabilization thread form; and
machining at least one flute along the implant body in a second helical direction generally opposite the first helical direction, whereby at least one cutting element is created at an intersection of the at least one flute and the threads.

26. The method of claim 25, wherein at least one flute is machined along the implant body before machining the external threads.

27. The method of claim 25, further comprising treating the dental implant with a particle blast process.

28. The method of claim 25, further comprising placement of the implant into a bone medium at a placement site of a human or animal subject, wherein the placement comprises application of a peak insertion torque of less than or equal to about 90 N cm.

29. The method of claim 28, wherein the peak insertion torque for implantation is less than or equal to about 75-79 N cm.

30. The method of claim 28, wherein the implant body upon placement provides stability sufficient to resist a lateral force of about 13.5 lbf.
